(19) United States
(12) Patent Application Publication
(10) Pub. No.: US 2006/0068916 A1
(43) Pub. Date: Mar. 30, 2006

(54) Gaming server and gaming system

(75) Inventors: Nobukatsu Hiranoya, Tokyo (JP); Kentaro Hayashi, Tokyo (JP); Takashi Abe, Tokyo (JP); Akira Shimizu, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/229,746

(22) Filed: Sep. 20, 2005

(30) Foreign Application Priority Data
Sep. 30, 2004 (JP) 2004-287589
Sep. 30, 2004 (JP) 2004-287694

(51) Int. Cl. G06F 17/00

(52) U.S. Cl. 463/42

(57) ABSTRACT

A gaming server which is connected to a gaming machine on which a game is played which uses an image of a gaming object based on gaming object data showing a figure or other object appearing in a game. The gaming server loads, out of the gaming object data items indicating the characteristics of the gaming object, the gaming object data of another gaming object, which is a partner, onto the gaming object data of the main gaming object to generate other gaming object data, and for transmitting the generated gaming object data to the gaming machine. The gaming server also has communication processing unit for transmitting, to the gaming machine, at least one of the gaming object data items in which some or all of the characteristic elements are exchanged, of the two different gaming object data items of the gaming object data items configured with a plurality of characteristic elements indicating the characteristics of the gaming object.

### RELATED APPLICATIONS

This application claims the priority of Japanese Patent Application Nos. 2004-287589 and 2004-287694 filed on Sep. 30, 2004, which are incorporated by reference.

### BACKGROUND OF THE INVENTION

1. Field of the Invention

The present invention relates to a gaming server which is connected to a gaming machine on which can be played a game using an image of a gaming object which shows a figure or other object appearing in a game, and to a gaming system in which such a game can be played.

2. Description of the Prior Art

There has been conventionally known a gaming machine on which can be played a game by recording the identification information on a character appearing in a game in an object to be read such as a card, and displaying a game image using the character corresponding to the identification information read from the card or the like (so called a “video gaming machine”). For example, Japanese Unexamined Patent Publication No. 2002-301264 discloses a card game device in which is executed a soccer game by recording personal data (identification information) of a soccer player in a card which displays the soccer player, recording data (character data) indicating the skills and the like of the player in an IC chip which is different from the card, and reading the character data corresponding to the IC chip using the personal data inside the card. In this card game device, various teams can be organized by combining a plurality of cards, and also the skills and the like of the players can be improved in the trainings or matches in a game.

However, in the card game device described above, the character data is independent for each card, and is unable to be changed as long as the data in the IC chip is not updated. It is necessary to update the data in the IC chip by carrying out the game contents (the training and the like) again and again in order to change the character data, and this is a reason that a player gets tired of the game.

### SUMMARY OF THE INVENTION

The present invention is contrived to solve the above problems, and an object of the present invention is to provide a player with the fascinating aspect of a game in which is used an image of a gaming object which shows a figure or other object appearing in a game, and also to provide a gaming server and gaming system in which the characteristics of characters or the like appearing in a game may be changed.

In order to solve the above problems, the first characteristic of the present invention is a gaming server which is connected to a gaming machine on which a game is played which uses an image of a gaming object which shows a figure or other object appearing in a game, wherein the gaming server comprises loading and generating means for loading, out of the gaming object data items indicating the characteristics of the gaming object, the gaming object data of another gaming object onto the gaming object data of the main gaming object to generate other gaming object data, and communication processing means for transmitting the gaming object data generated from the above means to the gaming machine.

In this gaming server, by loading gaming object data of another gaming object data onto the gaming object data of the main gaming object to generate other gaming object data, and transmitting the gaming object data to the gaming machine, a game in which is used a gaming object image based on this gaming object data can be played.

The present invention further comprises gaming object data storage means for relating the gaming object data indicating the characteristics of a gaming object to the gaming object and storing it for each gaming object, wherein the loading and generating means may load the gaming object data of another gaming object, which is stored by the gaming object data storage means, onto the gaming object data of the main gaming object, which is stored by the gaming object data storage means, and generate other gaming object data corresponding to the main gaming object.

In this gaming server, the gaming object data of another gaming object is loaded onto the gaming object data of the main gaming object data, and other gaming object data corresponding to the main gaming object is generated.

Furthermore, the present invention is a gaming system on which a game is played which uses an image of a gaming object which shows a figure or other object appearing in a game, the gaming system comprising reading means for reading discrimination information from an object to be read which stores discrimination information corresponding to the gaming object, gaming object data storage means for relating gaming object data indicating the characteristics of the gaming object to the discrimination information and storing thus obtained gaming object data for each gaming object, gaming object data extraction means for extracting, from the gaming object data storage means, the gaming object data corresponding to the discrimination information read from the object to be read by the reading means, and loading and generating means for loading gaming object data of another gaming object onto the gaming object data of the main gaming object out of the gaming object data items extracted by the above means, and generate other gaming object data.

In this gaming system, another gaming object data is loaded onto the main gaming object data corresponding to the discrimination information stored in the object to be read, and other gaming object data is generated.

Moreover, the present invention further comprises player information reading means for reading player information which identifies a player who plays the game, wherein the gaming object data storage means may relate the gaming object data to the player information and discrimination information to store the gaming object data for each gaming object, and the gaming object data extraction means may extract the gaming object data corresponding to the player information and the discrimination information which are read by the player information reading means and the reading means, from the gaming object data storage means.

In this gaming system, the gaming object data is related to the player information and the discrimination information, and is stored for each gaming object. Even if there are the same discrimination information, as long as the player information are different, other gaming object data is stored, and another gaming object data is loaded onto the main gaming object data extracted from the stored gaming object data, and other gaming object data is generated.

Moreover, the present invention comprises an arcade server installed in a game arcade, a plurality of gaming machines connected communicably to the arcade server via dedicated lines, and an in-arcade router installed in the game arcade, wherein the arcade server is connected to a gaming server via the in-arcade router, communication lines and the Internet.

Further, in the present invention, the gaming machine comprises another gaming object data loading instruction information input means in which a player inputs instruction for loading the gaming object data of another gaming object, and wherein another gaming object data loading instruction information which is input from the another gaming object data loading instruction information input means is transmitted to a gaming server.

Moreover, in the present invention, when the gaming server receives the another gaming object data loading instruction information, the loading and generating means loads the gaming object data of another gaming object, which is stored in the gaming object data storage means, onto the gaming object data of the main gaming object, which is stored in the gaming object data storage means, on the basis of the another gaming object data loading instruction information, and generates other gaming object data.

Further, in the gaming system of the present invention, the player information is stored in an ID card.

Further, in order to solve the above problems, the second characteristic of the present invention is a gaming server which is connected to a gaming machine on which a game is played which uses an image of a gaming object which shows a figure or other object appearing in a game, gaming server comprising data exchange means for exchanging some or all of a plurality of characteristic elements, which indicate the characteristics of the gaming object, for two different gaming object data items of the gaming object data configured by the plurality of characteristic elements, and communication processing means for transmitting at least one of the gaming object data items with the characteristic elements exchanged by the above means, to the gaming machine.

In this gaming server, some or all of the characteristic elements configuring the gaming object data are exchanged between the gaming object data items, and the gaming object data items with the exchanged characteristic elements are transmitted to the gaming machine, and thereafter the gaming machine can play the game in which is used the gaming object image based on these gaming object data items.

The present invention further comprises gaming object data storage means for relating the gaming object data configured by the plurality of characteristic elements indicating the characteristics of the gaming object to the gaming object, and storing thus obtained gaming object data for each gaming object, wherein the data exchange means may exchange some or all of the characteristic elements between the two different gaming object data items which are stored by the gaming object data storage means.

In this gaming server, the gaming object data configured by the plurality of characteristic elements indicating the characteristics of the gaming object is related to the gaming object and is stored in the gaming object data storage means for each gaming object, and some or all of the characteristic elements are exchanged between the two different gaming object data items which are stored by the gaming object data storage means.

In addition, the present invention is a gaming system in which a game is played which uses an image of a gaming object which shows a figure or other object appearing in a game, the gaming system comprising reading means for reading discrimination information from an object to be read in which is stored discrimination information corresponding to the gaming object, gaming object data storage means for relating gaming object data configured by a plurality of characteristic elements indicating the characteristics of the gaming object to the discrimination information, and storing thus obtained gaming object data for each gaming object, gaming object data extraction means for extracting the gaming object data from the gaming object data storage means based on the discrimination information which is read from the object to be read by the reading means, and data exchange means for exchanging some or all of the characteristic elements which configure two different gaming object data items extracted by the above means.

In this gaming system, two different gaming object data items are extracted based on two discrimination information items which are read by the reading means, and some or all of the characteristic elements configuring the gaming object data are exchanged between the two extracted gamine object data items.

The present invention further comprises player information reading means for reading player information for identifying a player, wherein the gaming object data storage means may relate the gaming object data to the player information and the discrimination information, and store the gaming object data for each gaming object, and the gaming object data extraction means may extract the gaming object data from the gaming object data storage means based on the player information and the discrimination information which are read by the player information reading means and the reading means.

In this gaming system, the gaming object data is related to the player information and the discrimination information, and is stored for each gaming object. Even if there are the same discrimination information, as long as the player information are different, other gaming object data is stored, and some or all of the characteristic elements configuring the gaming object data are exchanged between the two gaming object data items.

Further, in the present invention, the gaming machine comprises an exchange element identification information input means in which a player inputs instruction for exchanging some or all of the characteristic elements configuring the two different gaming object data items as the exchange elements, wherein exchange element identification information which is input from the exchange element identification information input means is transmitted to the gaming server.

In addition, in the present invention, when the gaming server receives the exchange element identification information, the data exchange means exchanges some or all of the characteristic elements configuring the two different gaming object data items stored in the gamine object data storage means, based on the exchange element identification information.

### BRIEF DESCRIPTION OF THE DRAWINGS

FIG. 1 is a system configuration diagram of a gaming system which is equipped with a plurality of gaming machines according to the present invention;

FIG. 2 is a perspective view showing the plurality of gaming machines and a card machine;

FIG. 3 is a perspective view showing the entire configuration of a gaming machine;

FIG. 4 is a block diagram of the gaming machine, which mainly shows the internal configuration thereof;

FIG. 5 is a block diagram showing an example of the internal configuration of an image control circuit;

FIG. 6 is a block diagram showing an arcade server;

FIG. 7 is a block diagram showing a game server and a database server;

FIG. 8A is a diagram showing a figure management file according to the first embodiment;

FIG. 8B is a diagram showing the figure management file according to the second embodiment;

FIG. 9A is a diagram showing an example of the figure management file according to the first embodiment after a character data loading process;

FIG. 9B is a diagram showing an example of the figure management file according to the second embodiment after a character data exchange process;

FIG. 10A is a diagram showing another example of the figure management file according to the first embodiment after the character data loading process;

FIG. 10B is a diagram showing another example of the figure management file according to the second embodiment after the character data exchange process;

FIG. 11 is an exploded perspective view showing a configuration of a play figure;

FIG. 12 is a side view showing a figure of an arm;

FIG. 13 is a flow chart showing an operation procedure of a game process from the start of the game to the end of the game in the gaming machine;

FIG. 14A is a flow chart showing an operation procedure of a game start process according to the first embodiment;

FIG. 14B is a flow chart showing an operation procedure of a game start process according to the second embodiment;

FIG. 15A is a flow chart showing an operation procedure of a character generation process according to the first embodiment;

FIG. 15B is a flow chart showing an operation procedure of a character generation process according to the second embodiment;

FIG. 16A is a flow chart showing an operation procedure of a character data loading selection process according to the first embodiment;

FIG. 16B is a flow chart showing an operation procedure of a character data exchange selection process according to the second embodiment;

FIG. 17A is a sequence chart showing an operation sequence which is performed among the gaming machine, arcade server and center server group according to the first embodiment;

FIG. 17B is a sequence chart showing an operation sequence which is performed among the gaming machine, arcade server and center server group according to the second embodiment; and

FIG. 18 is a flow chart showing an operation procedure of a character data loading process.

FIG. 19 is a flow chart showing an operation procedure of a process in a with-figure game;

FIG. 20 is a flow chart showing an operation procedure of a process in a no-figure game;

FIG. 21 is a flow chart showing an operation procedure of a shift phase process;

FIG. 22 is a flow chart showing an operation procedure of a movement phase process;

FIG. 23 is a figure showing an image of a labyrinth;

FIG. 24 is a figure showing another image of the labyrinth;

FIG. 25 is figure showing a fight selection image; and

FIG. 26 is a figure showing a battle image.

### DESCRIPTION OF THE PREFERRED EMBODIMENTS

Embodiments of the present invention are described hereinafter. It should be noted that the same reference characters are used to indicate the same elements, thus the overlapping explanations are omitted accordingly. It should be noted that the present embodiments include the first embodiments in which the gaming object data of another gaming object, which is a partner, is loaded onto the gaming object data of the main gaming object to generate other gaming object data, and the second embodiment in which some or all of a plurality of characteristic elements, are exchanged for two different gaming object data items of the gaming object data configured by the plurality of characteristic elements. However, both embodiments have some common contents, so basically the first embodiment is explained, and chiefly only the difference is explained additionally in the latter embodiment. Therefore, when merely describing the embodiments, the descriptions of the first embodiment and a part of the second embodiment which is common to the first embodiment are included, but the second embodiment is explained specifically only when there is a mention of “second embodiment”.

(The Entire Configuration of the Gaming System)

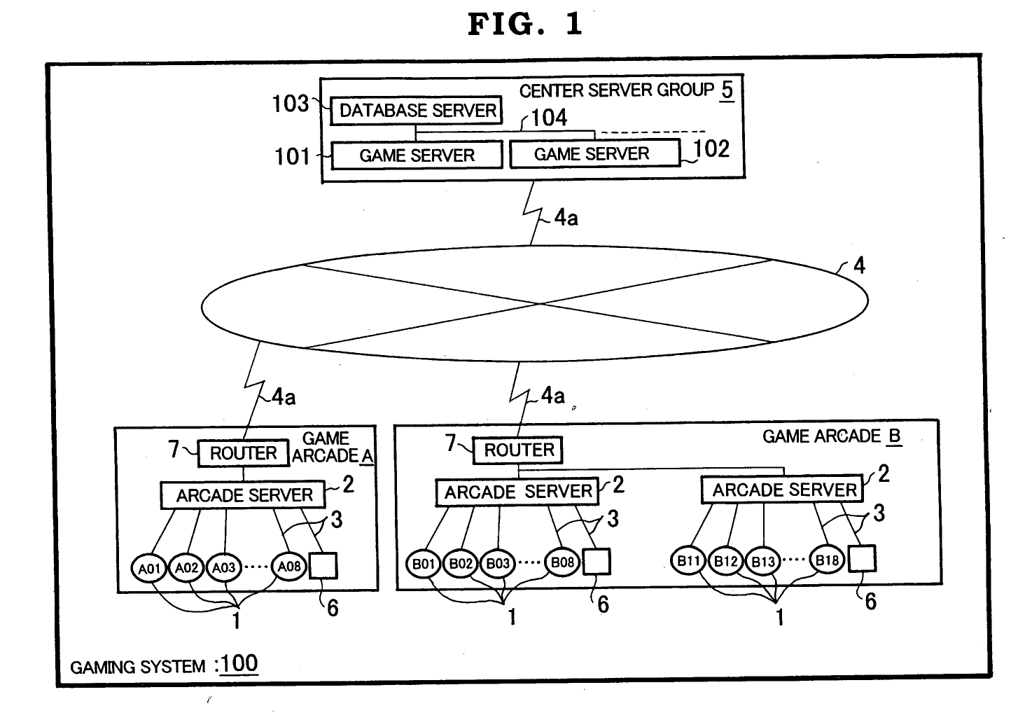

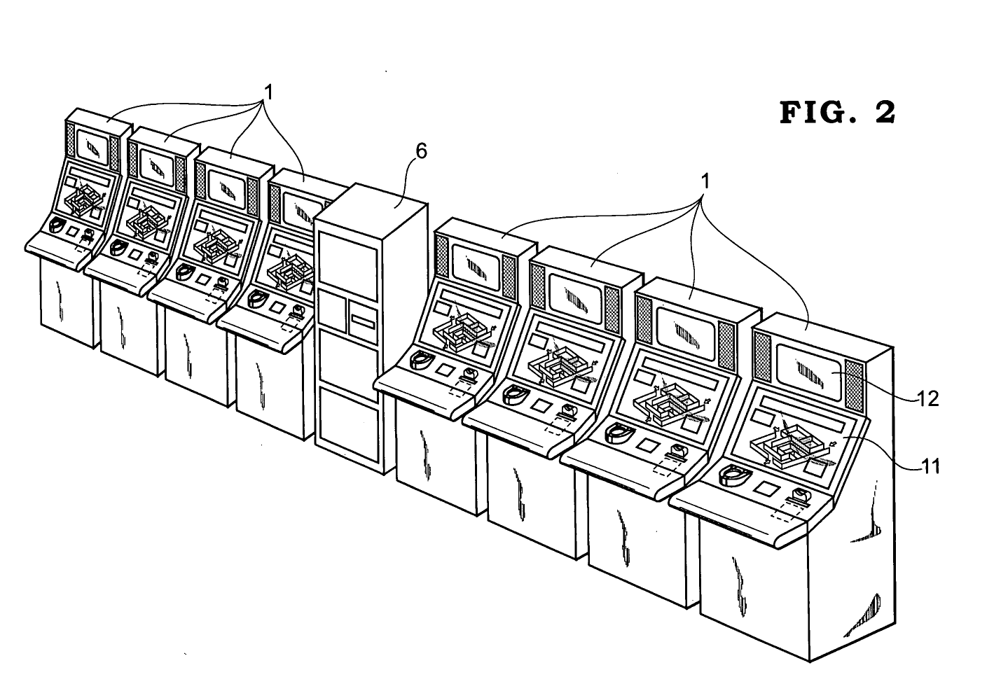

FIG. 1 is a system configuration diagram of a gaming system 100 which is equipped with a plurality of gaming machines 1 according to the present invention and FIG. 2 is a perspective view showing the plurality of gaming machines 1 and a card machine 6. The gaming system 100 is the same as the gaming system of the present invention, and has two game arcades A and B that are provided with one and two arcade servers 2 respectively, totaling three arcade servers, the plurality of gaming machines 1 (eight machines in the present embodiment) and card machines 6 connected communicably to the arcade servers via dedicated lines, an in-arcade router 7 provided in each of the game arcades A and B, and a center server group 5 connected to the in-arcade routers 7 via communication lines 4a and the Internet 4. It should be noted that the center server group 5 has game servers 101 and 102, and a database server 103, and the data base server 103 is the same as the gaming server of the present invention in the present embodiment.

In each of the game arcades A and B, the arcade server 2 is connected to the gaming machines 1 and card machine 6 via dedicated lines 3 to form an in-arcade LAN (Local Area Network), which is then connected to the Internet 4 via the in-arcade router 7.

(Configuration of the Gaming Machine)

The gaming machine 1 is the same as the gaming machine of the present invention, and has image display means for displaying a gaming object image which shows a gaming object such as a play character moving in response to an operation of a player (the detail will be described later) or an arm character showing an arm item (for example, a bow and arrow, shield, and armor) used by the play character, thus the gaming machine is configured so as to play a game which allows the character to perform an action in response to an operation of the player or to use the arm item. The gaming machine 1 is designed such that a game can be played in which the character moves within a labyrinth while following the route selected by the player, battles another character (an operated character that performs the action according to a selection made by other player, or a unoperated character which is caused to perform the action by the gaming machine) to compete for the items that the characters have (a sacred gem which will be described later in the present embodiment), and defeats a character of the final target after collecting all of the items (hereinafter called “labyrinth battle game”). In this labyrinth battle game, the obtained scores of each character (called “life” in the present embodiment) are increased or decreased according to a battle result or the progress of the game, and the character that loses all the scores thereof becomes a loser.

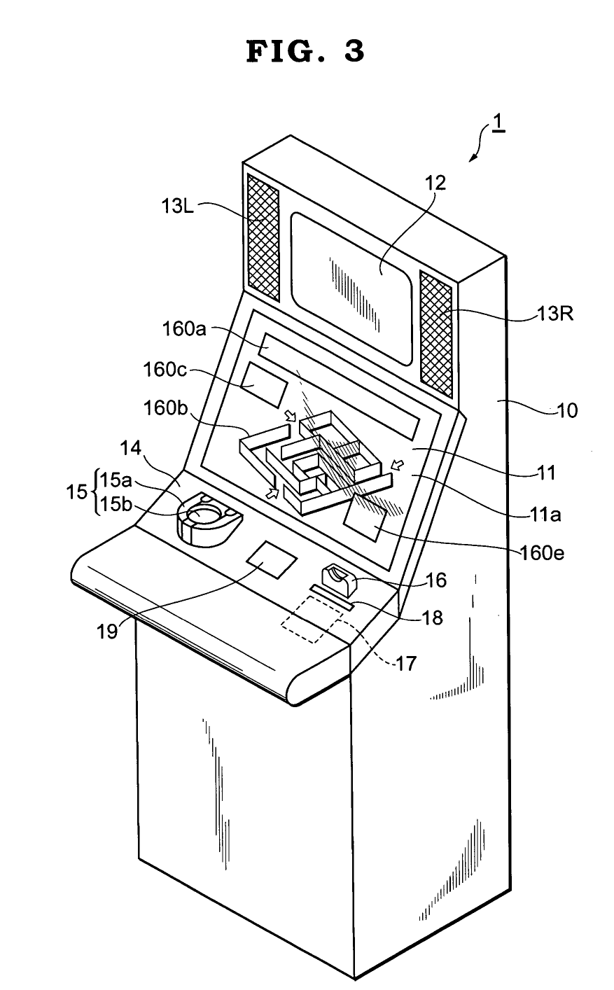

The gaming machine 1 has a main display 11 equipped with a liquid crystal display at the front of a housing 10, as shown in FIG. 3. The gaming machine 1 further has a sub display 12, also equipped with a liquid crystal display in an upper portion of the main display 11, and both right and left sides of the sub display 12 are disposed with speakers 13L and 13R for outputting sound used for effects of a game.

The main display 11 is the image display means, and is designed to display a game image (for example, a labyrinth image 160 and the like) for each step in a game (the detail will be described later). The sub display 12 is designed to display an image (for example, a battle image 180 and the like, which will be described later) in a specified step of the game.

Also, the gaming machine 1 has an operation panel 14 on the lower side of the main display 11. The left side of the operation panel 14 is disposed with an authentication unit 15, and the right side of same is disposed with a coin insertion slot 16 for inserting a coin (a gaming medium such as hard currency, a medal, or the like) necessary for executing a game, and a card slot 18 for inserting an ID card 17. The operation panel also has an operation unit 19 which is equipped with an operation button and the like.

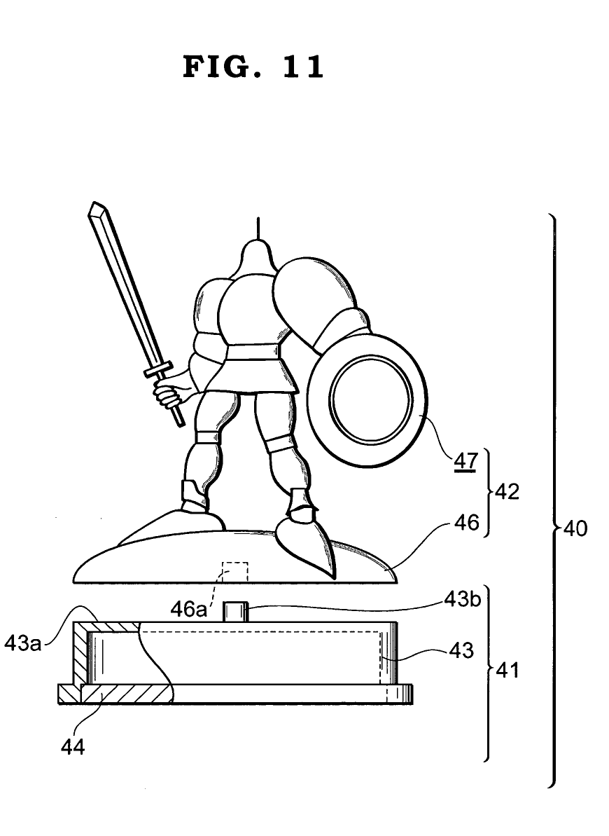

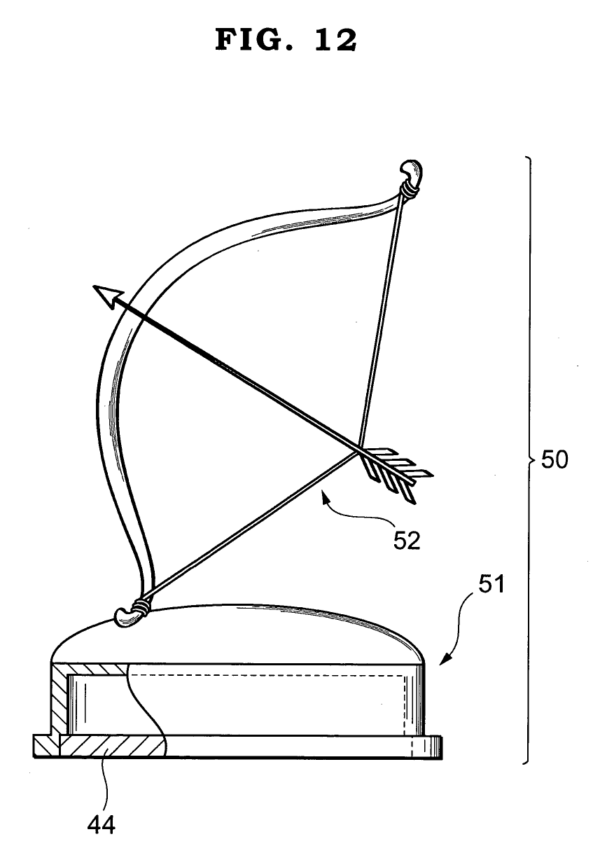

The authentication unit 15 is the same as the reading means in the present invention, and has a base mounting portion 15a and a reading portion 15b fixed on the surface of the operation panel 14. This base mounting portion 15a has inside a thick disk-like recess corresponding to the shape of base portions 41, 51 in an after-mentioned play figure 40 (see FIG. 11) or an item figure 50 (see FIG. 12) (referred to as “figures for game” when naming the both generically hereinafter), and the base portions 41, 51 can be fit and mounted in the recess. The reading portion 15b is disposed in the recess of the base mounting portion 15a, has an IC chip reader, which is not shown, and uses the IC chip to read out the recorded information from an IC chip 44 that is embedded in the base portions 41, 51 of the mounted figures for game 40, 50. It should be noted that the authentication unit 15 has an LED, and exposes the after-mentioned figures for game 40, 50 to light during the read operation of the figures. It should be noted in the present embodiment that the figures for game 40, 50 are the same as the objects to be read in the present invention, but in the second embodiment, only the figure for game 40 is the object to be read of the present invention.

Each of the gaming machines 1 that configures the gaming system 100 is given a machine-specific machine ID. The machine ID has a server ID inherent in each of the arcade server 2, and an ID inherent in each of the gaming machines 1. For example, each of the gaming machines 1 installed in the arcade A has an ID of A01, A02, A03 etc.

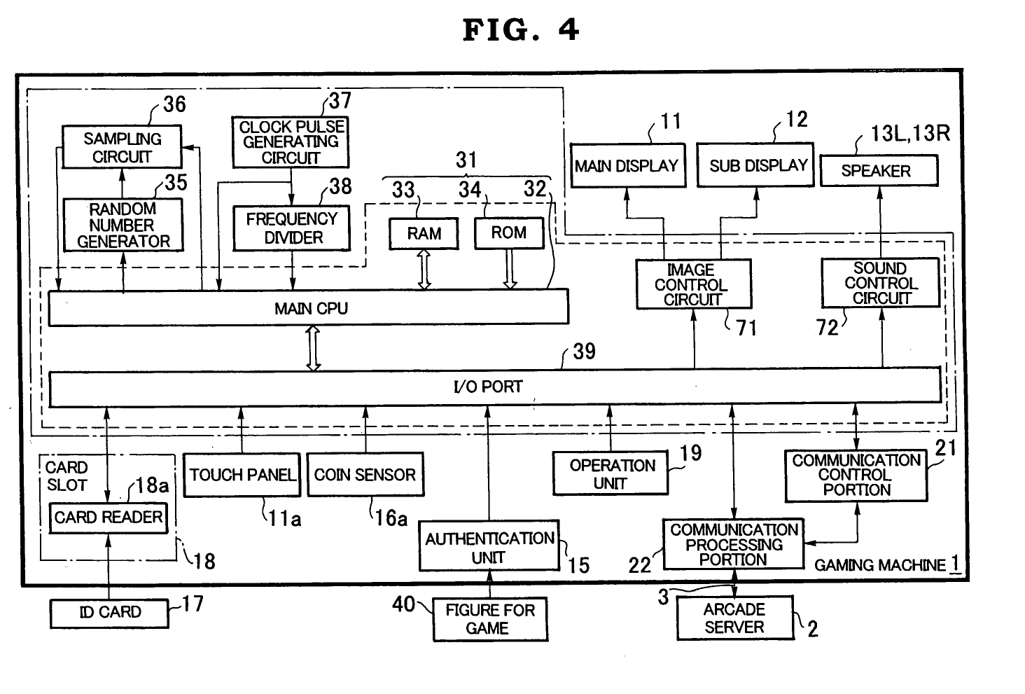

FIG. 4 is a block diagram of the gaming machine 1, which mainly shows the internal configuration thereof. The gaming machine 1 has a plurality of components, with a microcomputer 31 as the center of the components.

The microcomputer 31 has a main CPU (Central Processing Unit) 32, RAM (Random Access Memory) 33 and ROM (Read Only Memory) 34. The main CPU 32 operating according to a program stored in the ROM 34 inputs a signal from each component provided in the operation panel 14 and at the same time performs input and output of the signal to and from other components by means of I/O port 39 to perform operation control of the entire gaming machine 1. Data or programs (application data or game data in the present embodiment, which will be described later) used when the main CPU 32 operates are stored in the RAM 33. A control program executed by the main CPU 32 and permanent data are stored in the ROM 34.

The gaming machine 1 further has a random number generator 35, a sampling circuit 36, a clock pulse generating circuit 37, and a frequency divider 38. The random number generator 35 operates according to an instruction from the main CPU 32 to generate a certain range of random numbers. The sampling circuit 36 extracts an arbitrary random number from the random numbers generated by the random number generator 35 according to the instruction from the main CPU 32, and inputs the extracted random number to the main CPU 32. The clock pulse generating circuit 37 generates a reference clock for operating the main CPU 32, and the frequency divider 38 inputs a signal, which is obtained by dividing the reference clock at a constant frequency, to the main CPU 32.

Moreover, the gaming machine 1 has a touch panel 11a, a coin sensor 16a, a card reader 18a, a communication control portion 21, a communication processing portion 22, an image control circuit 71, and a sound control circuit 72.

The touch panel 11a is the operating means, is provided so as to cover the display screen of the main display 11, detects a position of a spot that the player touched, and inputs a position signal corresponding to the detected position to the main CPU 32. The player uses the touch panel 11a to perform an operation input for determining a performance of the character. For example, in the touch panel 11a, a conductive material is applied onto the surface of a rectangular transparent plate, and voltage is applied from the electrodes disposed on the four corners of the transparent plate, whereby a slight current change which is caused when a finger of the player touches to the plate is sensed by means of the electrodes, and the position of the spot that the player touched is detected.

The coin sensor 16a detects a coin inserted into the coin insertion slot 16, and outputs a detection signal corresponding to the detection to the main CPU 32. The card reader 18a reads out card information of a player ID or the like, which is recorded in the ID card 17 inserted into the card slot 18, and inputs the read card information to the main CPU 32. In the present embodiment the player ID is the same as the player information for identifying a player who can play the game, and the card reader 18a is the same as the player information reading means.

The communication control portion 21 operates according to an instruction from the main CPU 32, and controls the connection or disconnection of a line used for a communication with the arcade server 2. The communication processing portion 22 operates according to an instruction from the communication control portion 21, and executes data transmission which is performed through the dedicated lines 3.

The image control circuit 71 controls an image display in the main display 11 and the sub display 12, and allows the main display 11 and the sub display 12 to display various images such as those showing characters.

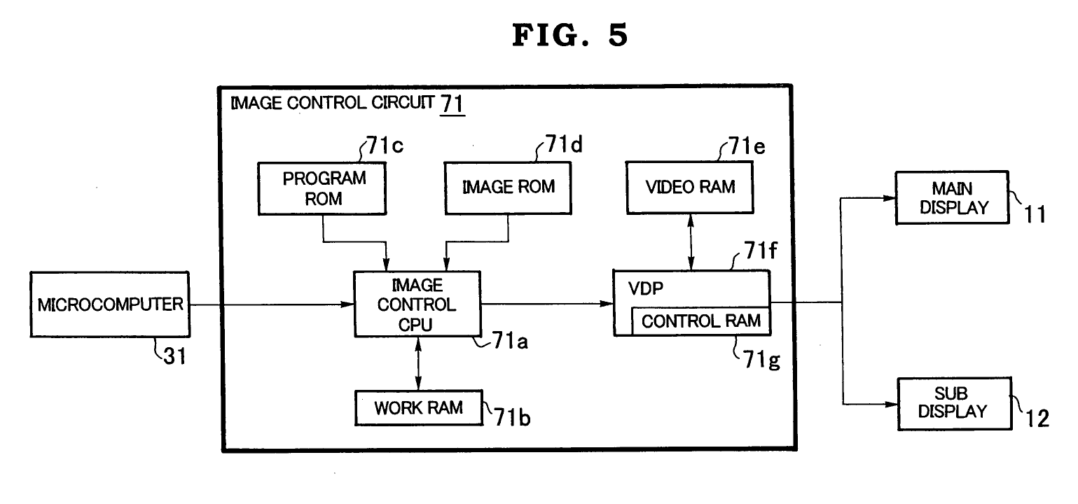

The image control circuit 71 has an image control CPU 71a, a work RAM 71b, a program ROM 71c, an image ROM 71d, a video RAM 71e, and a VDP (Video Display Processor) 71f, as shown in FIG. 5. The image control CPU 71a determines images to be displayed by the main display 11 and the sub display 12 according to an image control program which is stored in the program ROM 71c beforehand (relates to display on the main display 11 and the sub display 12), based on a parameter set by the microcomputer 31. The work RAM 71b is configured as temporary storage means for when the image control CPU 71a executes the image control program.

The program ROM 71c has stored therein the image control program, various selection tables or the like. The image ROM 71d has stored therein dot data for forming images. The video RAM 71e is configured as temporary storage means for when forming images by means of the VDP 71f. The VDP 71f has a control RAM 71g, forms images corresponding to the contents displayed by the main display 11 and the sub display 12 which are determined by the image control CPU 71a, and outputs each of the formed images to the main display 11 and the sub display 12.

The sound control circuit 72 inputs a sound signal for outputting a sound from the speakers 13L and 13R, to the speakers 13L and 13R. Sounds for bringing an excitement to a game at an appropriate time is outputted from the speakers 13L and 13R after, for example, the start of a game.

(Configurations of the Arcade Server, Card Machine, and In-Arcade Router)

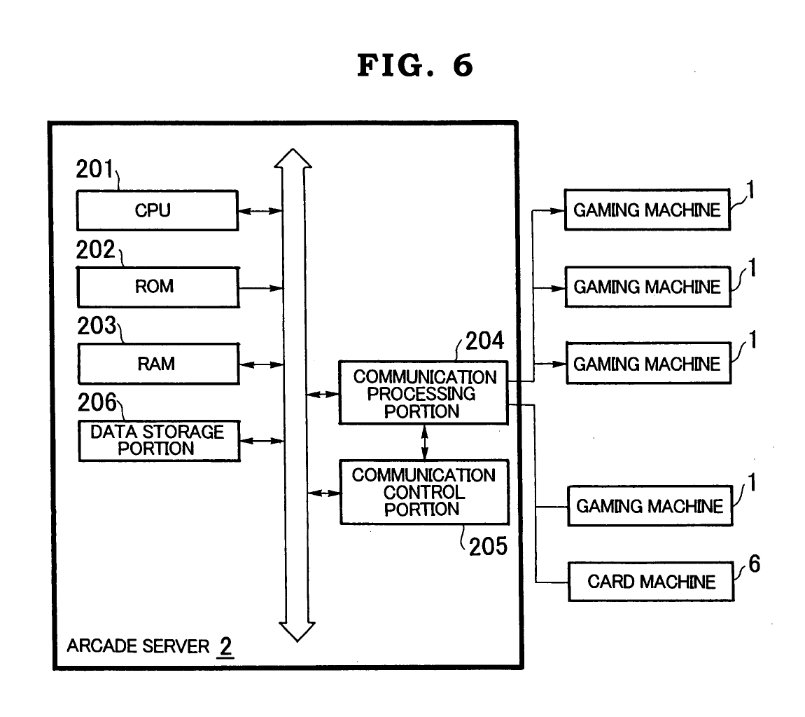

As shown in FIG. 6, the arcade server 2 has a CPU 201, ROM 202, RAM 203, communication processing portion 204, communication control portion 205 and data storage portion 206 which has stored therein application data. The CPU 201 operates while reading and writing the data into and from the RAM 203 according to the programs stored in the ROM 202, and at the same time the communication control portion 205 activates the communication processing portion 204 according to an instruction from the CPU 201. The arcade server 2 performs data transmission with each of the gaming machines 1 set in each of the game arcades A and B via the dedicated lines 3 to transmit (download) the application data to each of the gaming machines 1, or relays the data transmission between the gaming machines 1 and with the center server group 5. The application data include various data used in execution of a labyrinth battle game carried out in the gaming machine 1 (image data for games, and the like), and data for boards (a program for settings for relating the operation buttons equipped in the operation unit 19 to the labyrinth battle game).

The card machine 6 has an operation portion for the player to perform an input operation of the personal information, and card issuing means, wherein the card issuing means allows storage of the card information containing the player ID (the player information) inherent in the player, and issues the ID card 17 by means of a predetermined input operation using the operation portion.

The in-arcade router 7 connects an in-arcade LAN, which is formed in each of the game arcades A and B, to a LAN formed in the center server group 5, via the communication lines 4a and the Internet 4.

(Configuration of the Center Server Group)

The center server group 5 has a plurality of game servers (two game servers 101 and 102 in FIG. 1) that are installed for each game, and a database server 103, wherein the game servers are connected to each other via dedicated lines 104 to form a LAN, which is connected to the Internet 4 via an unshown router.

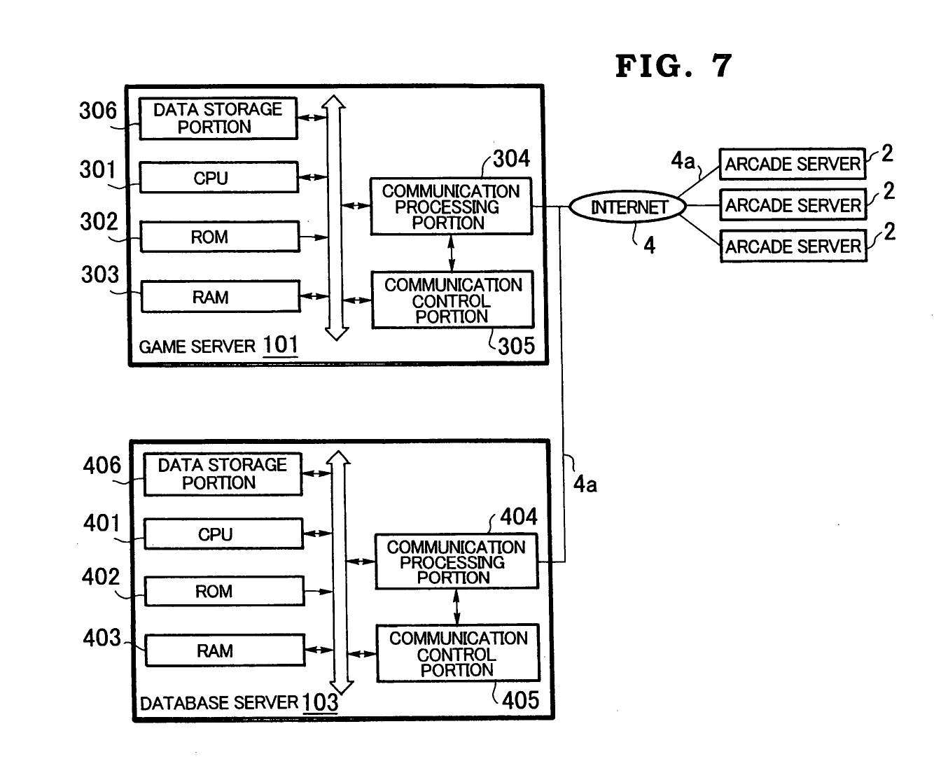

The game server 101 is installed in order to execute the labyrinth battle game, and, as shown in FIG. 7, has a CPU 301, ROM 302, RAM 303, communication processing portion 304, communication control portion 305, and data storage portion 306. In the game server 101, the CPU 301 operates while reading and writing the data into and from the RAM 303 according to the programs stored in the ROM 302, and at the same time the communication control portion 305 activates the communication processing portion 304 according to an instruction from the CPU 301.

The game server 101 performs data transmission with each of the arcade servers 2 via the Internet 4. Then the game server 101 receives after-mentioned entry data which is transmitted from each of the gaming machines 1, updates acceptance of participation (entry) of a player to a labyrinth battle game and also participation information of the player, determines a player as an opponent, and transmits a result obtained to the database server 103.

The game server 102 is installed for executing another game, and has the same configuration as the game server 101, although the data or programs stored therein are different from the game server 101.

The database server 103 is the gaming server in the present invention, and has a CPU 401, ROM 402, RAM 403, communication processing portion 404, communication control portion 405, and data storage portion 406. In the database server 103, the CPU 401 operates while reading and writing the data into and from the RAM 403 according to the programs stored in the ROM 402, and at the same time the communication control portion 405 activates the communication processing portion 404 according to an instruction from the CPU 401, and performs data transmission with each of the arcade servers 2 via the Internet 4. The data storage portion 406 has stored therein the game data, the player ID, a password used for authenticating the player and the type of a game.

The game data includes character-specific data which indicates the characteristics of each character (information indicating a costume for each character, the color of the costume, survival power, magical power, attacking power, defensive power against a physical attack, magical attacking power, magical defensive power, a character ability value having an attack range, a special ability (including an item with which the character is armed, effects that the item has, and the like in the second embodiment in particular). Such information is referred to as “figure information”), and data indicating a history of a labyrinth battle game played by each player. This game data is transmitted from the database server 103 to the gaming machine 1 and is used in a labyrinth battle game. It should be noted that, among the figure information items described above, the numeric data which indicates the characteristics of each character (survival power, magical power, attacking power, and the like) is called “character data”, which is the same as the gaming object data of the present invention.

The player ID is read from the ID card 17 and transmitted from the gaming machine 1. As is described hereinafter, in the gaming machine 1 each player sets a figure for game 40 and 50 in the authentication unit 15, the figure being used by the player, and allows the figure ID to be read, whereby the read figure ID corresponding to the figure for game 40 and 50 is transmitted from the gaming machine 1 to the database server 103. In the database server 103, a figure management file 60, which relates a plurality of corresponding figure IDs to one player ID transmitted from the gaming machine 1 and can store the obtained IDs, is formed in the data storage portion 406. Moreover, the player ID and figure ID are related to the character data of each character corresponding to the player ID and figure ID, and these related IDs and data are stored in the figure management file 60, and used in after-mentioned authentication of a player and figure, extraction of the character data, character data loading process (the character data exchange process in the second embodiment) and the like. It should be noted that in the present embodiment the data storage portion 406 in which the figure management file 60 is formed is the same as the gaming object data storage means of the present invention.

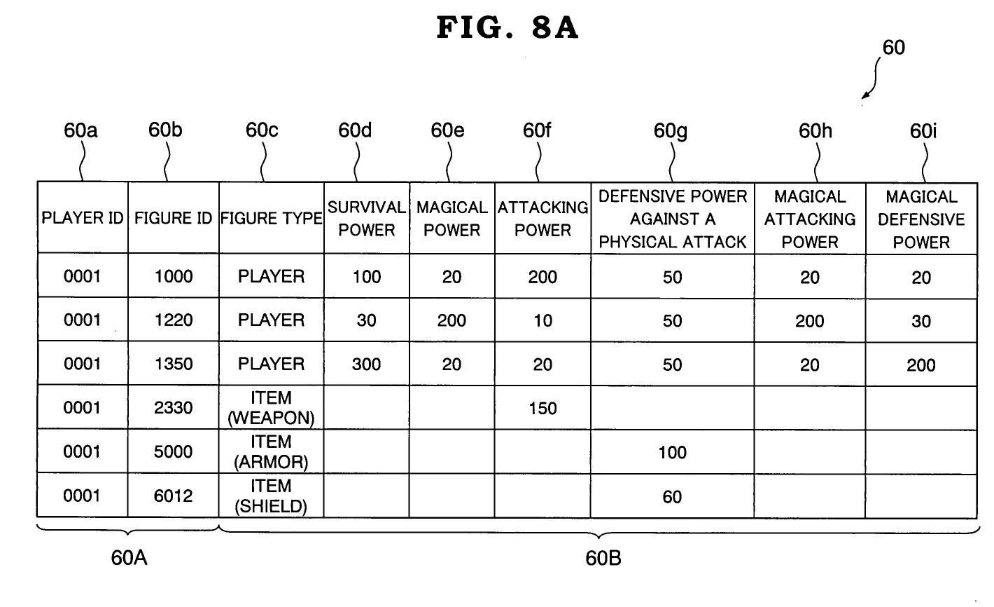

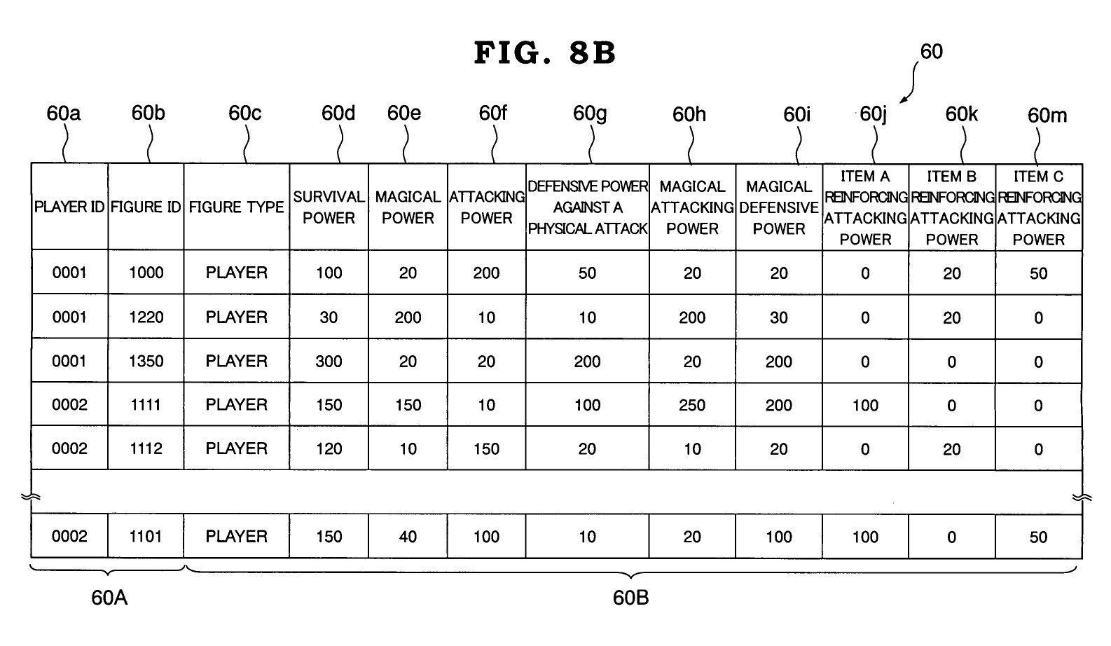

FIG. 8A shows the figure management file 60 according to the first embodiment, in which are shown a plurality of records where the player ID corresponds to “0001”. The figure management file 60 has an ID management area 60A and a character management area 60B, where a player ID 60a and a figure ID 60b are set in the ID management area 60A. Moreover, there are set in the character management area 60B the items which configure the character data unique to each character, such a figure type 60c, survival power 60d, magical power 60e, attacking power 60f, defensive power against a physical attack 60g, magical attacking power 60h, and magical defensive power 60i.

The player ID 60a and figure ID 60b are the items as indexes for each of the records stored in the figure management file 60, and four digit numbers corresponding to the player IDs or figure IDs are stored. The figure type 60c is an item which indicates an attribute of the figure, and classified broadly into “player” and “item”. “Player” means a figure corresponding to a play character which performs an action in response to an operation of the player, and “item” means a figure corresponding to an arm character. On the other hand, the items such as the survival power 60d, magical power 60e and the like are items as the characteristic elements configuring the character data, expressing the abilities of the character numerically, where the large and small numerical values correspond to the high and low abilities.

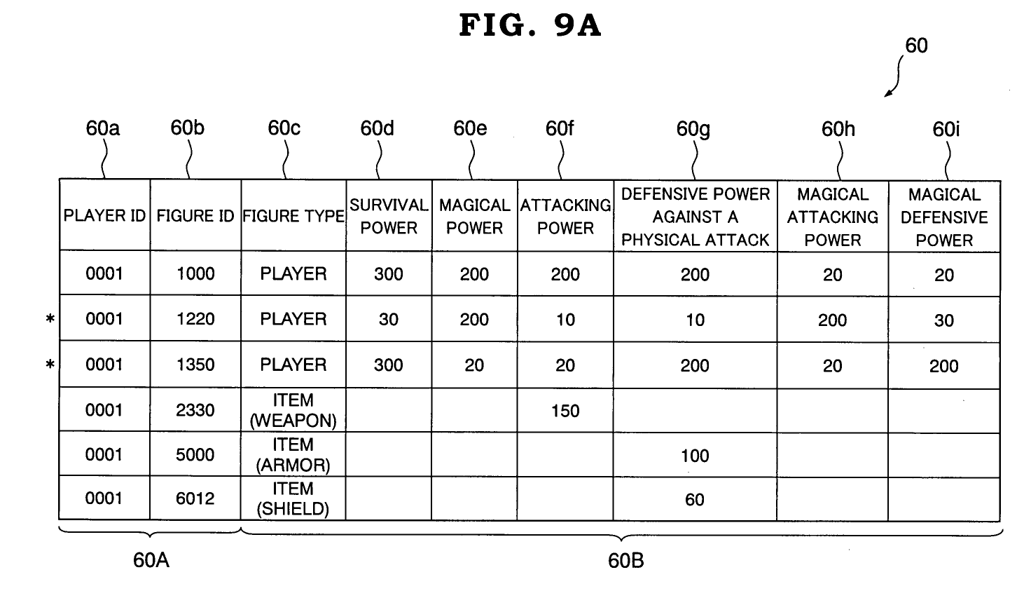

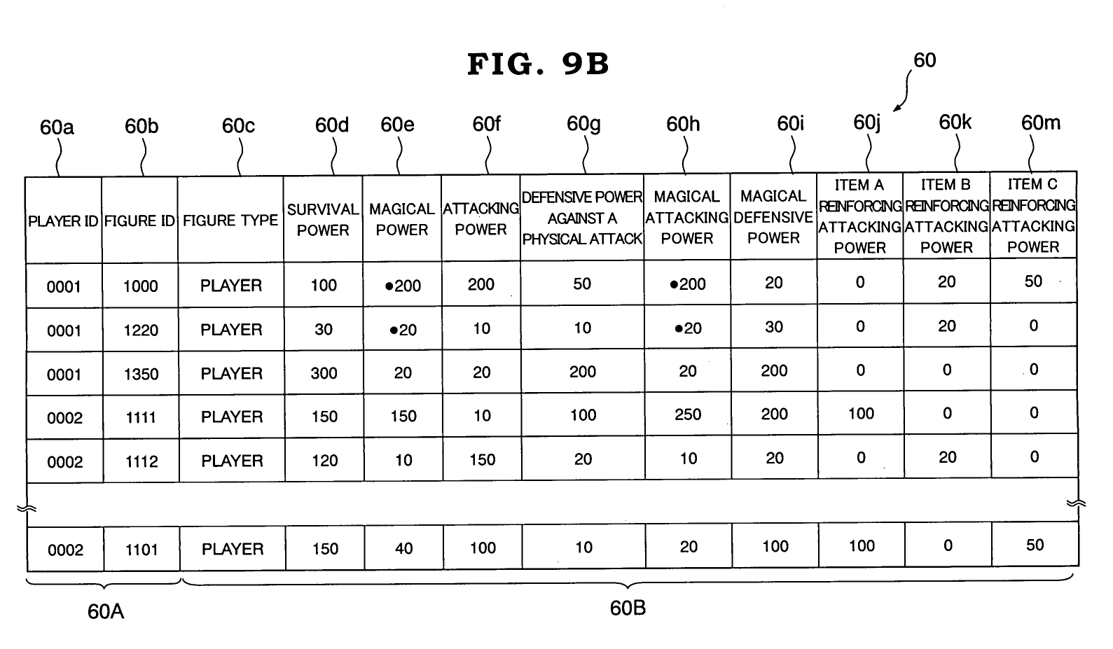

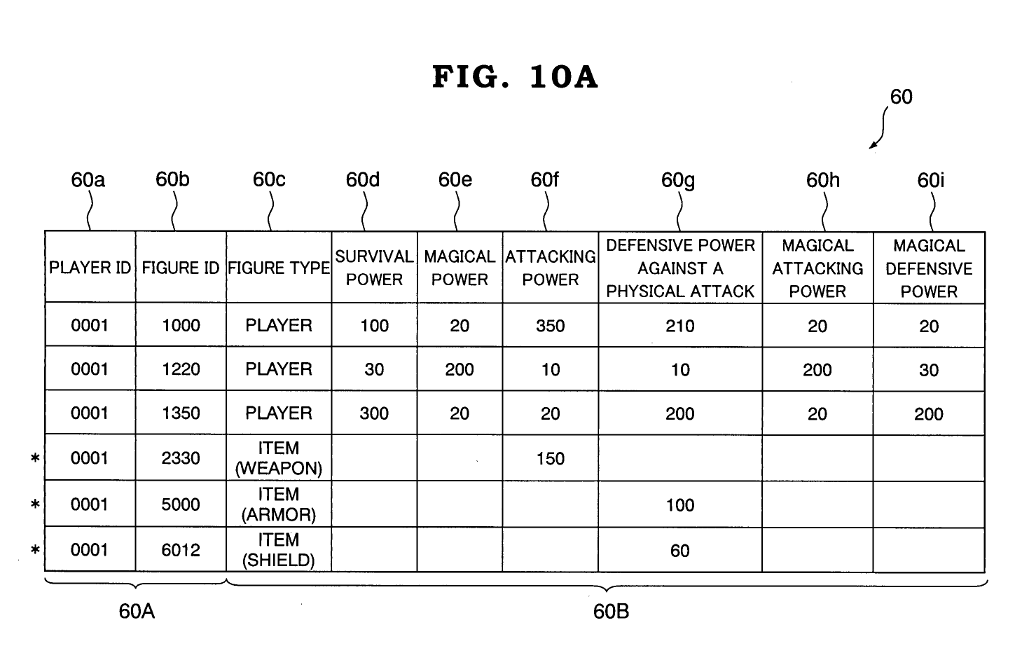

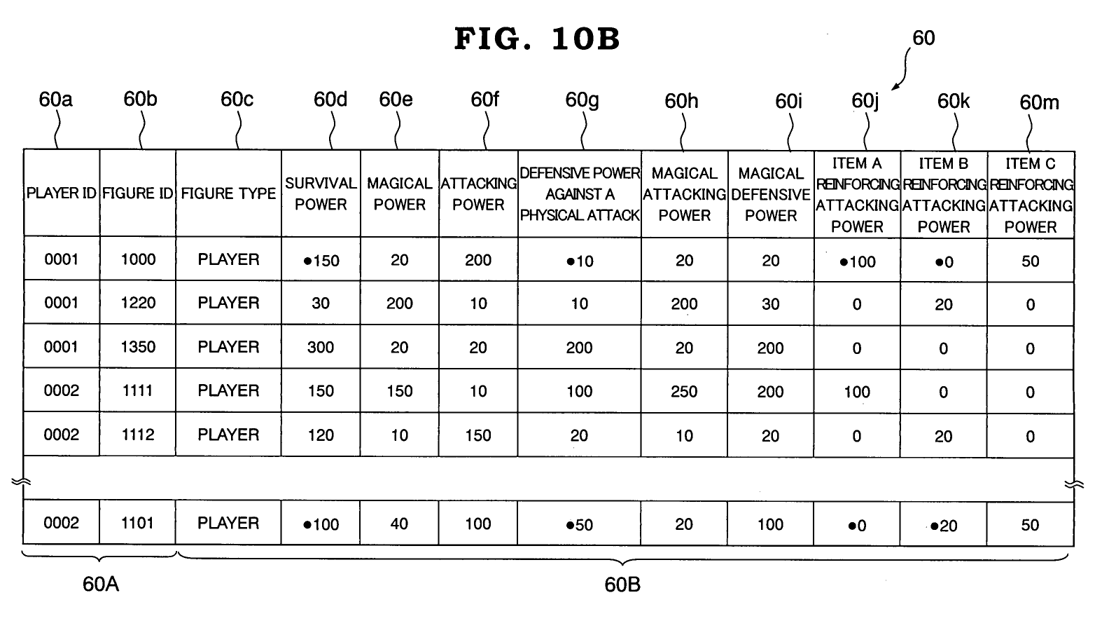

It should be noted that FIG. 9A and FIG. 10A show the figure management file 60 obtained after the character data loading process. The record corresponding to a character of the partner (* in each of the figures), which is selected as an object for the loading process, is deleted. The character data loading process is described in detail hereinafter.

FIG. 8B shows the figure management file 60 according to the second embodiment, in which are shown a plurality of records where the player IDs correspond to “0001”, “0002”, and “0012”. The figure management file 60 has an ID management area 60A and a character management area 60B, where a player ID 60a and a figure ID 60b are set in the ID management area 60A. Moreover, there are set in the character management area 60B the items which configure the character data unique to each character, such a figure type 60c, survival power 60d, magical power 60e, attacking power 60f, defensive power against a physical attack 60g, magical attacking power 60h, magical defensive power 60i, item A 60j, item B 60k, and item C 60m.

The player ID 60a and figure ID 60b are the items as indexes for each of the records stored in the figure management file 60, and four digit numbers corresponding to the player IDs or figure IDs are stored. The figure type 60c is an item which indicates an attribute of the figure, and classified broadly into “player” and “item”. “Player” shown in FIG. 8B means a figure corresponding to a play character which performs an action in response to an operation of the player, and “item” (not shown) means a figure corresponding to an arm character. On the other hand, the survival power 60d, magical power 60e and the like, and items such as the item A 60j, item B 60k, and item C 60m are the characteristic elements configuring the character data, expressing the abilities of the character numerically, where the large and small numerical values correspond to the high and low abilities. It should be noted that the item A 60j, item B 60k and item C 60m are the items that numerically express the increase and decrease of the abilities corresponding to the items held by the characters, and in the present embodiment they exemplify the items for strengthening the attacking power, and also express a numerical value which is added to the attacking power of the characters.

It should be noted that FIG. 9B and FIG. 10B show the figure management file 60 obtained after the character data exchange process. The characteristic elements of the character data, which are selected as an object for the exchange process, are shown in • in each of the figures. The character data exchange process is described in detail hereinafter.

(Configuration of the Figure)

FIG. 11 is an exploded perspective view showing a configuration of the play figure 40. The play figure 40 has the base portion 41, and a figure main body portion 42 representing a three-dimensional shape of each figure appearing in the labyrinth battle game.

The base portion 41 has a size of the recess formed in the base mounting portion 15a, and is formed into a hollow thick disk-like shape. The base portion 41 has a base main body portion 43 having a top portion 43a, the base main body portion being in the form of a cylinder with a bottom, and the IC chip 44, wherein the IC chip 44 is embedded and fixed into an opening end portion of the base main body portion 43. Further, the base portion 41 has a protruding portion 43b in substantially a center of the top portion 43a of the base main body portion 43. The IC chip 44 has stored therein a figure ID inherent in a character corresponding to the figure main body portion 42. It should be noted that in the present embodiment the figure ID is the same as the discrimination information corresponding to the gaming object of the present invention.

The figure main body portion 42 has a leveling pad portion 46 having a concave portion 46a corresponding to the protruding portion 43b, and a doll portion 47 which is formed such that it stands on two legs on the leveling pad portion 46, and models the character appearing in the labyrinth battle game, wherein the protruding portion 43b is embedded in the concave portion 46a so that the figure main body 42 is fixed to the top portion 43a of the base portion 41. It should be noted that the play figure 40 is placed in a capsule with a diameter of approximately 7 cm which is not shown, and is sold in the same machine as the card machine 6. Monster figures are placed in a few capsules, thus, when using the play figure 40 (with-figure mode, which is described hereinafter), sometimes the monster figures can be used. Moreover, even with the same figure, by making its color different or changing the character data, which is described hereinafter, the characteristic property of the character can be expressed to motivate the player's intentions of collection.

Play figure 40 can be identified by the player according to the shape of the figure main body portion 42, and also can be identified by the gaming machine 1 in accordance with the figure ID. The figure ID is unique to a different play figure 40, and thus is designed so that multiple registration of the same figure in the gaming system 100 is prohibited.

FIG. 12 is a side view showing a configuration of an arm figure 50. The arm figure 50 has a base portion 51, and a figure main body portion 52 representing a three-dimensional shape of an arm (a bow and arrow, shield, armor or the like) which is held or used by the play character appearing in the labyrinth battle game. As with the play figure 40, the arm figure 50 can be identified by the player according to the shape of the figure main body portion 52, and also can be identified by the gaming machine 1 according to the figure ID. The configuration and the like of the arm figure 50 are basically the same as those of the play figure 40, thus the same reference numerals are applied in FIG. 12, omitting the detailed explanation.

(Operation Contents of the Gaming Machine)

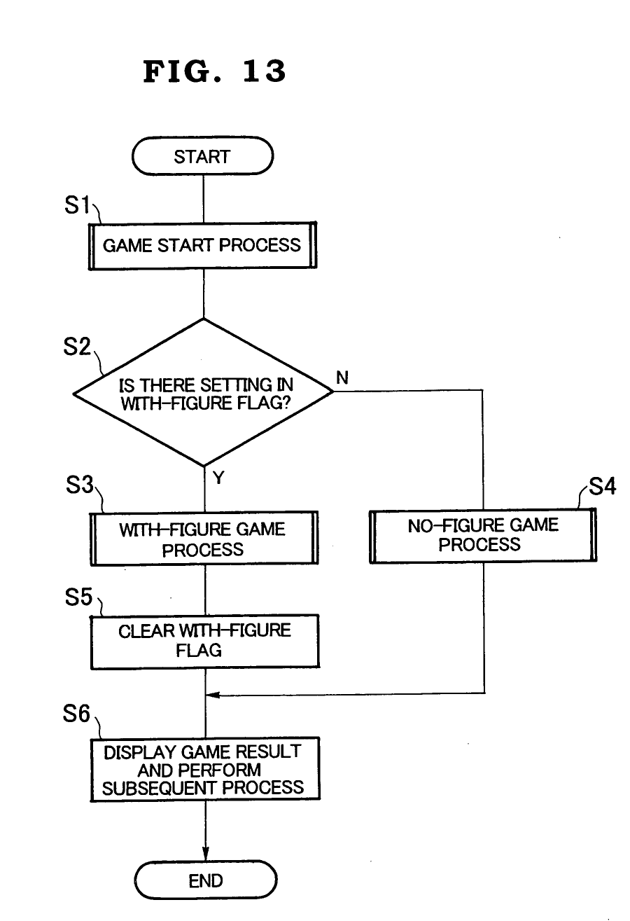

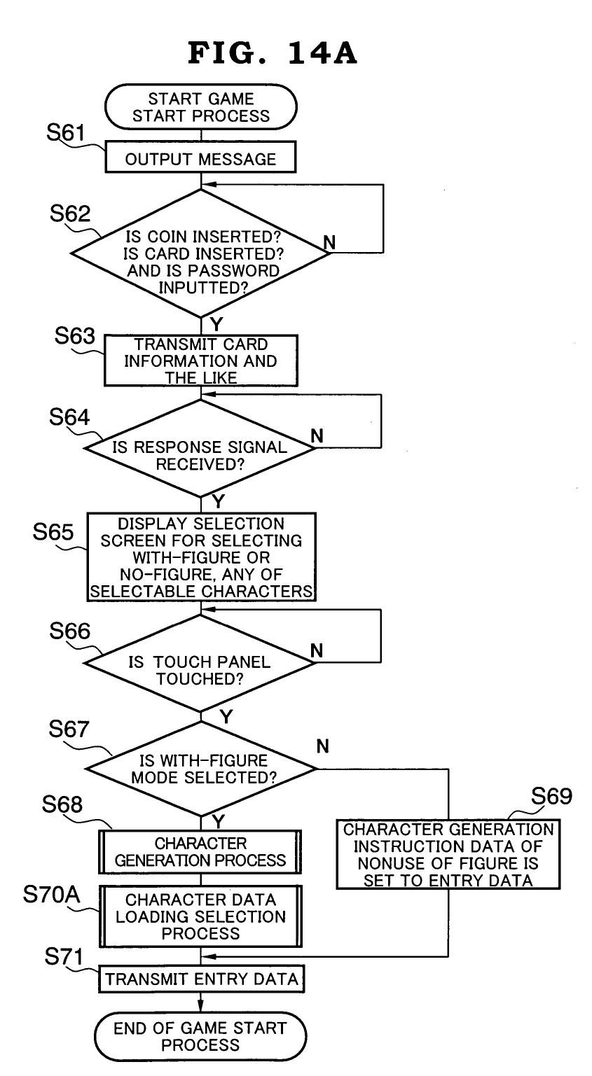

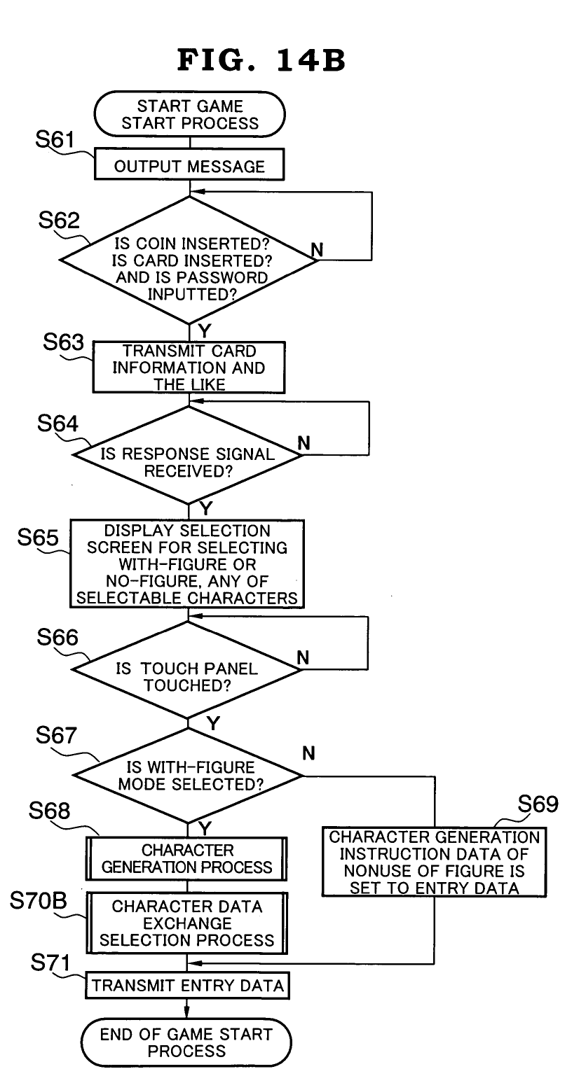

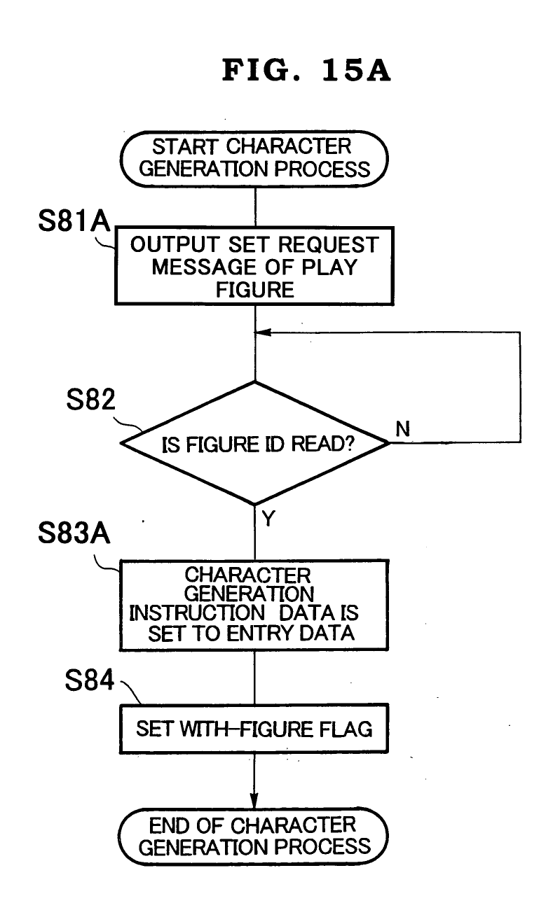

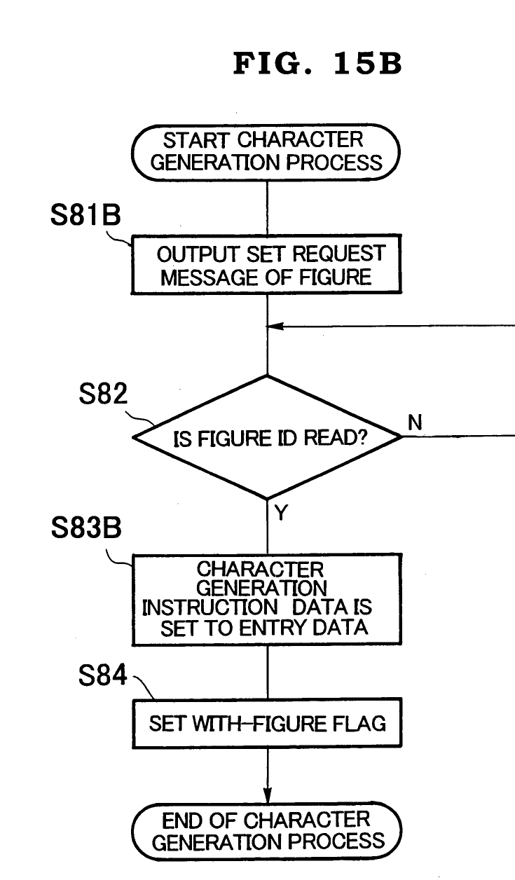

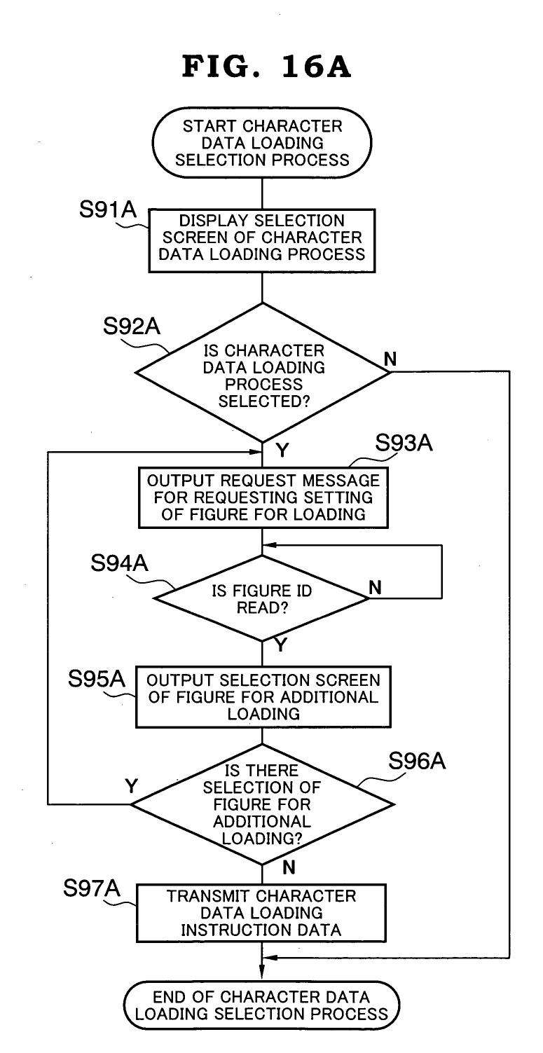

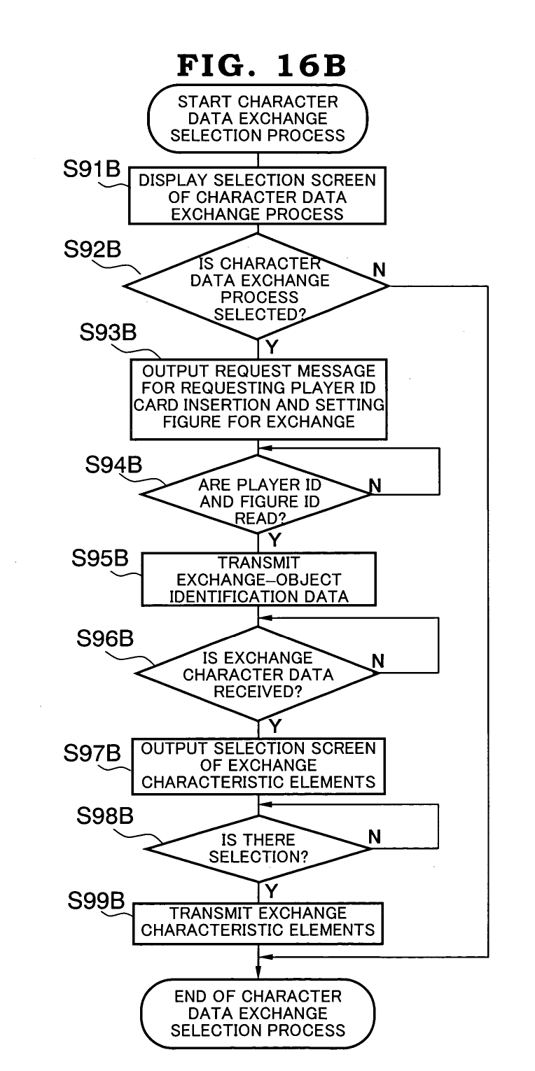

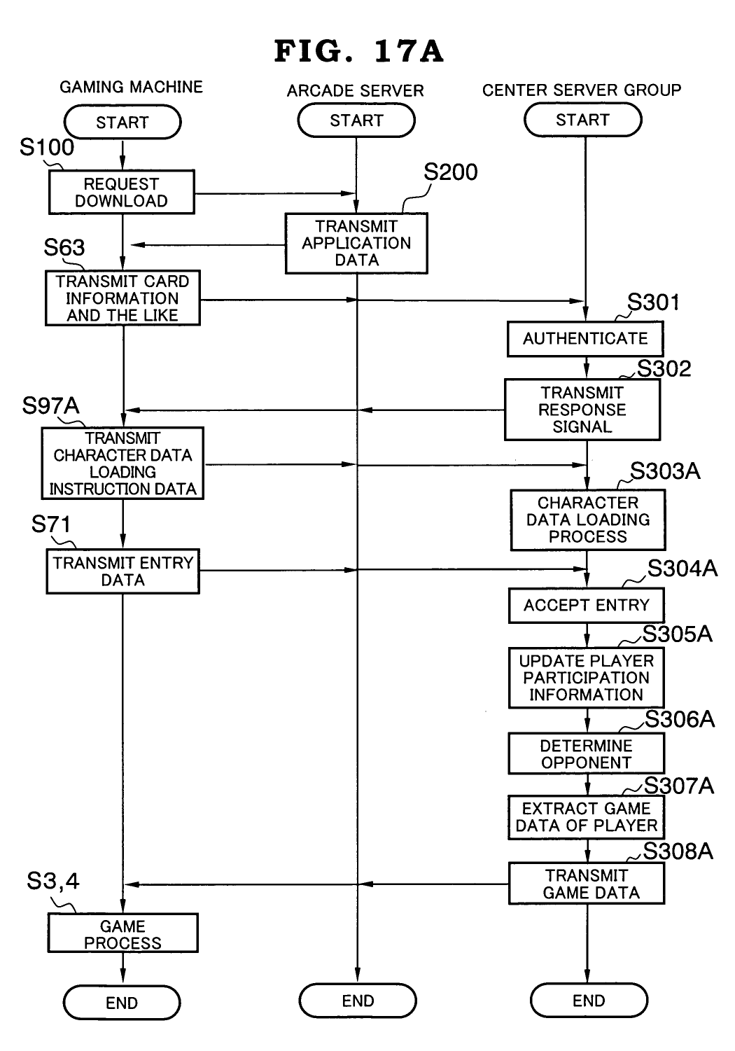

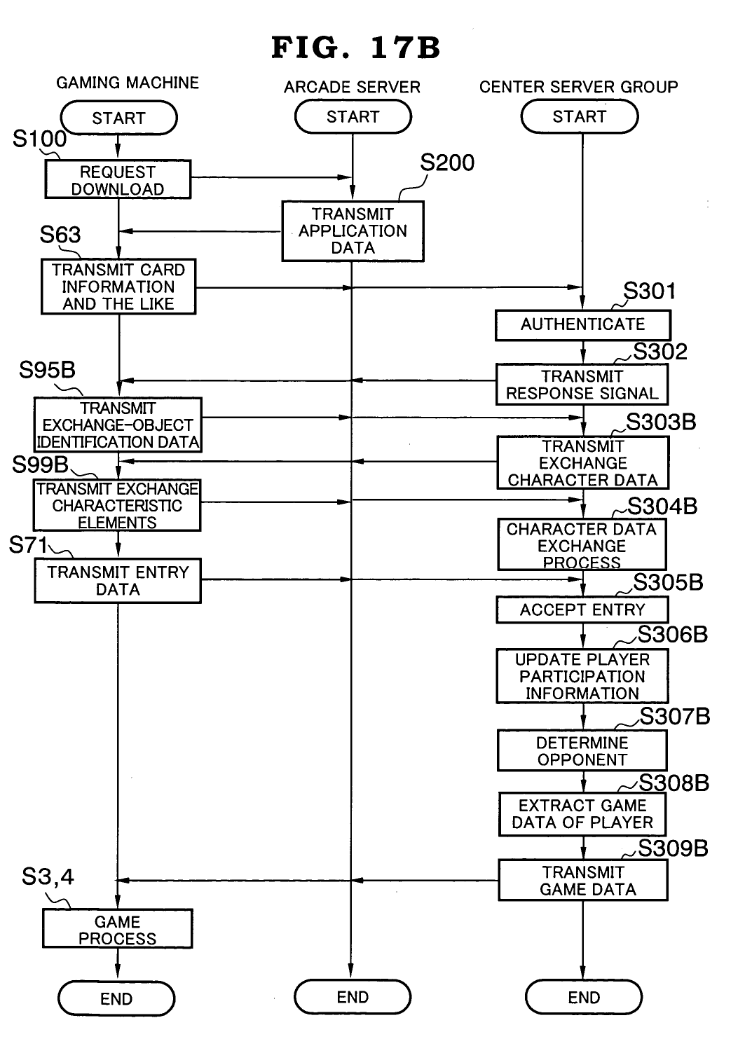

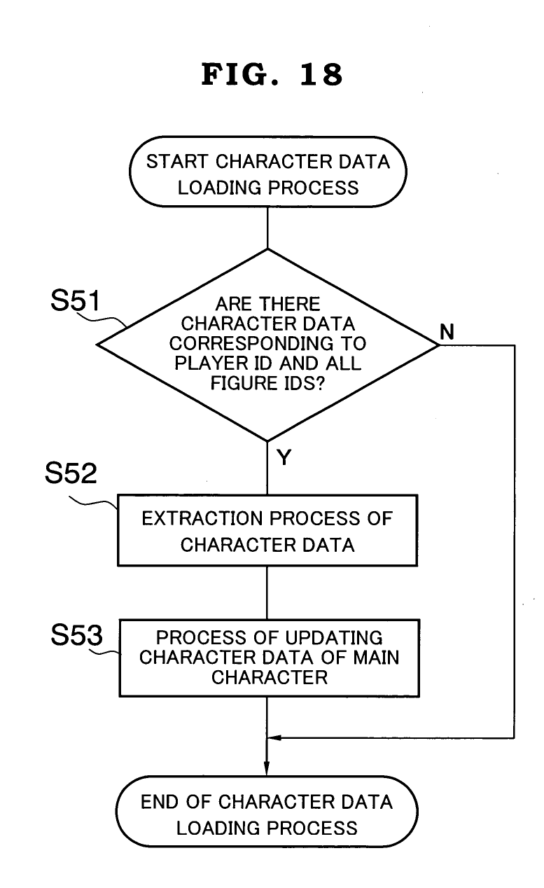

Next, the details of the operation of the gaming machine 1 having the above-described configuration are described with reference to the flow charts shown in FIG. 13 through FIG. 22. It should be noted that the explanation below is provided by taking a case as an example in which, of eight gaming machines 1 installed in the game arcade A, four gaming machines 1 are operated by the players respectively to play the same labyrinth battle game. In addition, configurations unique to the first embodiment are shown in FIG. 13, FIG. 14A, FIG. 15A, FIG. 16A, FIG. 17A and FIG. 18, whereas configurations unique to the second embodiment are shown in FIG. 13, FIG. 14B, FIG. 15B, FIG. 16B and FIG. 17B.

FIG. 13 is a flow chart showing an operation procedure of a game process from the start to the end of the game in the gaming machine 1. It should be noted that steps are abbreviated to S in FIG. 13 and after-mentioned FIG. 14A through FIG. 22. In the description below, one of the gaming machines 1 operated by the four players is taken as an example.

The gaming machine 1 transmits a download request of application data to the arcade server 2 when the power is turned on (step 100, which will be describe later), and at the same time when the arcade server 2 receives the download request, the application data is transmitted to the gaming machine 1 which sent the download request (see FIGS. 17A and 17B).

Once receiving the application data, the gaming machine 1 stores the application data in the RAM 33. Then, once the main CPU 32 reads the application data, in the gaming machine 1 the main CPU 32 operates as the game progress control means to proceed with the labyrinth battle game according to operation input of the player. Each of the gaming machines 1 causes the main display 11 to display a game image while synchronizing with other gaming machines via the arcade server 2 and the center server group 5.

When a game process is started, each gaming machine 1 proceeds to a step 1 to perform an after-mentioned game start process, which includes coin insertion, ID card insertion, password input and character generation process. In a step 2, it is determined whether or not predetermined data is set (setting is present) to a with-figure flag, which is described hereinafter, based on a result of the game start process. The processing is divided into a step 3 and 4 according to a result from this determination (step 3 in the case of a setting in the with-figure flag, and step 4 in the case of no setting). Either one of the processes is carried out, and when the with-figure flag is cleared in a step 5 which follows the step 3, the processing is proceeded to a step 6, in which a game result (battle result) such as the scores is displayed, whereas the game data is updated in the database server 103. Thus a subsequent process is performed for transmitting the data showing the battle result to the database server 103 via the arcade server 2, and then the process is ended.

In this manner, in the gaming machine 1 the labyrinth battle game can be played in either the with-figure mode or no-figure mode. With the with-figure mode, however, the content of the game is more beneficial for the players than that of the no-figure mode (the details will be described later).

(Game Start Process)

The game start process of the step 1 in the first embodiment is carried out by following the flow chart shown in FIG. 14A. FIG. 14A is a flow chart showing an operation procedure of a game start process, FIG. 15A is a flow chart showing an operation procedure of a character generation process, and FIG. 16A is a flow chart showing an operation procedure of the character data loading selection process.

The main CPU 32 proceeds to a step 61 once starting the game start process, to perform a message output processing, instruct the image control circuit 71, and cause the main display 11 to display a predetermined message (request for coin insertion, request for ID card insertion, and request for password input). Next, processing in steps 62 and 63 is executed.

In order to start a game, a player throws a coin into the coin insertion slot 6, inserts the ID card 17 into the card slot 18, and uses the operation unit 19 to input a password. Then, a signal from detecting the coin that is inserted is inputted from the coin sensor 16a to the main CPU 32, and the card information stored in the ID card 17 is inputted from the card reader 18a. Furthermore, the password is inputted from the operation unit 19, and when all of these input are performed, the processing proceeds to the step 63, in which the main CPU 32 instructs the communication control portion 21 to operate the communication processing portion 22, and the card information that is read and the inputted password are transmitted to the arcade server 2.

In a subsequent step 64, the main CPU waits until the after-mentioned response signal is received from the center server group 5, and when the response signal is received the processing proceeds to a step 65. In the step 65 an instruction is given to cause the main display 11 to display a selection screen for selecting with-figure mode or no-figure mode, and any of the various selectable characters after it is discriminated whether or not authentication (registration) is completed in accordance with the response signal. In a step 66 the main CPU waits until the touch panel 11a is touched, and if it is touched the processing proceeds to a step 67, in which it is determined whether the with-figure mode is selected or not in step 65. When the with-figure mode is selected in this step, the processing proceeds to a step 68, and if not, the processing proceeds to a step 69. After the character generation process is performed in the step 68, the processing proceeds to the character data loading selection process (step 70A), and then to the subsequent step 71. In the step 69, on the other hand, data for character generation instruction (non-figure character generation instruction) due to nonuse of the figure is set to the after-mentioned entry data, and the processing proceeds to a step 71. Specifically, in the step 67, if the player selects the with-figure mode when using a figure for the first time and also when there is an authenticated figure and another figure that is different from the authenticated figure is used, the processing proceeds to a step 68, in which the character generation process is performed. Further, when the player does not use a figure and when the player does not use an authenticated figure although there is one, if the player selects the no-figure mode, the processing proceeds to the step 69.

It should be noted in the second embodiment that the character data exchange selection process (step 70B) is performed instead of the character data loading selection process (step 70A), as shown in FIG. 14B.

When the processing proceeds to the step 71, the main CPU 32 instructs the communication control portion 21 to operate the communication processing portion 22, and transmits the entry data to the arcade server 2. When the step 71 is finished, the game start process is ended.

(Character Generation Process)

Furthermore, in the first embodiment, when the processing proceeds to the step 68, the main CPU 32 performs the character generation process according to the flow chart shown in FIG. 15A. When this process is started, the processing proceeds to a step 81A, in which an output processing for a set request message of the play figure 40 is performed. Here, the main CPU 32 instructs the image control circuit 71 and causes the main display 11 to display a message for requesting a setting in which the play figure 40 is mounted on the authentication unit 15 to read the figure ID (for example, “Please set the base of play figure to the authentication unit. When authentication of the play figure is started, the authentication unit lights up brightly. Please do not remove the play figure until the light is turned off.”). In a step 82 the main CPU waits until reading of the figure ID is finished. When the player sets the play figure 40 to the authentication unit 15 according to the displayed message, the authentication unit 15 reads the figure ID of the play figure 40 which is stored in the IC chip 44, and the figure ID is input to the main CPU 32. Then, the processing proceeds to a step 83A, in which the character generation instruction data having the figure ID read by the main CPU 32 is set to the entry data. It should be noted that the figure ID which is read in this step is a figure ID as the main figure ID in character generation (referred to as “main figure ID” hereinafter), and is used in the character data loading selection process which is described hereinbelow.

In a subsequent step 84, predetermined data (“1” in the present embodiment) is set to the with-figure flag which indicates that the authentication unit 15 reads the figure ID of the play figure 40 (figure setting), and when the step 84 is executed the character generation process is ended.

The game start process of the step 1 in the second embodiment is carried out by following the flow chart shown in FIG. 14B. FIG. 14B is a flow chart showing an operation procedure of the game start process, FIG. 15B is a flow chart showing an operation procedure of the character generation process, and FIG. 16B is a flow chart showing the operation procedure of the character data exchange selection process.

In the second embodiment, on the other hand, when the processing proceeds to the step 68, the main CPU 32 performs the character generation process according to the flow chart shown in FIG. 15B. When this process is started, the processing proceeds to a step 81B, in which an output processing for a set request message of the play figure 40 is performed. Here, the main CPU 32 instructs the image control circuit 71 and causes the main display 11 to display a message for requesting a setting in which the play figure 40 is mounted on the authentication unit 15 to read the figure ID (for example, “Please set the base of play figure to the authentication unit. When authentication of the play figure is started, the authentication unit lights up brightly. Please do not remove the play figure until the light is turned off.”). In a step 82 the main CPU waits until reading of the figure ID is finished. When the player sets the play figure 40 to the authentication unit 15 according to the displayed message, the authentication unit 15 reads the figure ID of the play figure 40 which is stored in the IC chip 44, and the figure ID is input to the main CPU 32. Then, the processing proceeds to a step 83B, in which the character generation instruction data having the figure ID read by the main CPU 32 is set to the entry data. It should be noted that the figure ID which is read in this step is a figure ID used for identifying a character which is a figure for exchange (referred to as “first figure ID” hereinafter), and is used in the character data exchange selection process which is described hereinbelow.

In a subsequent step 84, predetermined data (“1” in the present embodiment) is set to the with-figure flag which indicates that the authentication unit 15 reads the figure ID of the play figure 40 (figure setting), and when the step 84 is executed the character generation process is ended.

(Character Data Loading Selection Process)

Moreover, in the first embodiment, after the character generation process (step 68), the processing proceeds to the step 70A, where the main CPU 32 performs the character data loading selection process by following the flow chart shown in FIG. 16A. The character data loading selection process is a processing in which a player is allowed to select other character data of the character as the partner of the main character, and the character data loading instruction data for causing the database server 103 to perform the character data loading selection process is transmitted on the basis of the selection.

Once this process is started the main CPU 32 proceeds to a step 91A in which the main CPU 32 performs instruction for causing the main display 11 to display a selection screen to allow the player to select whether or not to perform the character data loading process. In a following step 92A the player touches the touch panel 11a, thereby it is determined whether or not the character data loading process is selected. If the character data loading process is selected here, the processing proceeds to a step 93A, and if the player selects “no need to perform character data loading process”, the character data loading selection process is ended.

In the step 93A the main CPU 32 instructs the image control circuit 71 to cause the main display 11 to display a message for requesting a setting of the figures for loading (play figure 40, arm figure 50). In a following step 94A the main CPU 32 waits until the figure ID is read. When the player sets the figures for loading in the authentication unit 15 according to the message displayed, the authentication unit 15 reads the figure ID stored in the IC chip 44 of the set figures for loading, and inputs them to the main CPU 32. The processing then proceeds to a step 95A in which an instruction is given to cause the main display 11 to display a selection screen for allowing the player to select whether or not there is an additional figure for loading. In a subsequent step 96A, if the player touches the touch panel 11a to select that there is an additional figure for loading, the processing returns to the step 93A and a series of processing is repeated in which the authentication unit 15 reads the figure ID of this additional figure for loading and inputs it to the main CPU 32. This read figure ID of the figure for loading is the figure ID of the partner (referred to as “partner figure ID”) as against the abovementioned main figure ID.

On the other hand, if the player selects that there is no additional figure for loading, the processing proceeds to a step 97A in which the main CPU 32 instructs the communication control portion 21 to operate the communication processing portion 22 to transmit the character data loading instruction data having the main figure ID, partner figure ID (all partner figure IDs if there are a plurality of partner figure IDs), and the player ID which is read from the ID card 17 during the game start process (step 62), to the database server 103 via the arcade server 2. When the character data loading instruction data transmission process is executed in the step 97A, the character data loading selection process is ended, and the processing proceeds to the step 71 (see FIG. 14A).

In this manner, in the gaming machine 1, when the setting of the play figure 40 is performed a predetermined data is set in the with-figure flag. If the player selects the character data loading selection process within a predetermined time period, the character data loading instruction data is transmitted to the database server 103 via the arcade server 2, and the character data loading process which is described hereinbelow is performed in the database server 103.

On the other hand, when character generation instruction data, which is involved in the setting of the play figure 40, is transmitted to the database server 103 via the arcade server 2, in the database server 103 the figure ID of the data is related to the player ID unique to the player who performs the setting, stored in the ID management area 60A of the figure management file 60, and is used for determining whether or not the play figure 40 is authenticated. A result of the determination whether or not the play figure 40 is authenticated is transmitted as a response signal from the database server 103 so that the player can select a character corresponding to the authenticated figure to player the labyrinth battle game. However, if the setting of the play figure 40 is not performed, the with-figure flag is not set, thus it is necessary to set the play figure 40 in the authentication unit 15 to allow the figure ID to be read in order to play the labyrinth battle game in the with-figure mode even if the play figure 40 is authenticated. Then after the setting, the figure information corresponding to the read figure ID is generated in the database server 103 so that the labyrinth battle game can be played even if the setting of the play figure 40 is not performed repeatedly.

(Character Data Exchange Selection Process)

On the other hand, in the second embodiment, after the character generation process (step 68), the processing proceeds to the step 70B in which the main CPU 32 performs the character data exchange selection process by following the flow chart shown in FIG. 16B. The character data exchange selection process is a processing in which a player is allowed to select the characteristic elements of two character data items which are to be exchanged in order to exchange the specific elements configuring the character data, and the data for causing the character data exchange process to be performed is transmitted to the database server 103 based on the selection.

Once this process is started, the main CPU 32 proceeds to a step 91B in which the main CPU 32 instructs the main display 11 to display a selection screen (character data exchange process selection screen) for allowing the player to select whether or not to perform the exchange processing of the character data. In a following step 92B it is determined whether or not the player selects the character data exchange process by touching the touch panel 11a. If the selection of the character data exchange process is made, the processing proceeds to a step 93B. If the layer selects “no need to perform character data exchange process”, the character data exchange selection process is ended.

In the step 93B the main CPU 32 instructs the image control circuit 71 and causes the main display 11 to output a message for requesting for a player ID card insertion and requesting for a setting of the exchange play figure 40 to the authentication unit 15, and, in a following step 94B, waits until the reading of the player ID and figure ID is finished. When the player inserts his ID card and sets the exchange play figure 40 to the authentication unit 15 according to the displayed message, the card reader 18a reads the player ID, and the authentication unit 15 reads the figure ID and inputs it to the main CPU 32, and then the processing proceeds to a following step 95B. It should be noted that the figure ID which is read above is a second figure ID which is used for identifying the exchange character.

In the step 95B, the main CPU 32 instructs the communication control portion 21 to operate the communication processing portion 22, and the exchange-object identification data, which has the player ID which is read when the game is started (step 62), the abovementioned first figure ID, the player ID which is read in the step 94B, and the second figure ID, is transmitted to the database server 103 via the arcade server 2.

In a subsequent step 96B, the main CPU 32 waits until the two character data items (exchange character data) corresponding to the exchange-object identification data are transmitted from the database server 103, and when the exchange character data is received, the processing proceeds to a step 97B.

In the step 97B, the main CPU 32 instructs the image control circuit 71 and causes the main display 11 to display each characteristic element (for example, the attacking power, magical power, item A, item B, and the like) which configures the two character data items which are to be exchanged, and to output a screen for selecting the characteristic element for exchange. In this case, some or all of the characteristic elements configuring the character data may be output.

In a following step 98B, the main CPU 32 waits until the player selects the characteristic element, and once the player touches the touch panel 11a to select the characteristic element, the processing proceeds to a step 99B in which the main CPU 32 instructs the communication control portion 21 to operate the communication processing portion 22, and the data (exchange characteristic element) related to the characteristic elements which are selected for exchange (for example, the magical power and magical attacking power) are transmitted to the database server 103 via the arcade server 2. When the exchange characteristic element transmission process of the step 99B is executed, the character data exchange selection process is ended, and he processing proceeds to the following step 71 (see FIG. 14B). The database server 103 which receives the exchange characteristic element data performs the character data exchange process (see FIG. 17B) which is described hereinafter.

In this manner, in the gaming machine 1, when the setting of the play figure 40 is performed, predetermined data is set to the with-figure flag. Moreover, if the player selects the character data exchange process, the exchange-object identification data is transmitted to the database server 103 via the arcade server 2, and in the database server 103 the two character data items corresponding to the exchange-object identification data are transmitted to the gaming machine 1. In the gaming machine 1 the player is allowed to select the characteristic elements of the character data for exchange according to the received character data, and the selected exchange characteristic element data is transmitted to the database server 103. In the database server 103 the exchange process for the character data, which is described hereinafter, is performed upon reception of the exchange characteristic element data.

On the other hand, when character generation instruction data, which is involved in the setting of the play figure 40, is transmitted to the database server 103 via the arcade server 2, in the database server 103 the figure ID of the data is related to the player ID unique to the player who performs the setting, is stored in the figure management file 60, and is used for determining whether or not the play figure is authenticated. A result of the determination whether or not the figure is authenticated is transmitted as a response signal from the database server 103 so that the player can select a character corresponding to the authenticated figure to player the labyrinth battle game. However, if the setting of the figure is not performed, the with-figure flag is not set, thus it is necessary to set the play FIG. 40 in the authentication unit 15 to allow the figure ID to be read in order to play the labyrinth battle game in the with-figure mode even if the figure is authenticated. Then after the setting, the character data corresponding to the read figure ID is generated in the database server 103 so that the labyrinth battle game can be played even if the setting of the play figure 40 is not performed repeatedly.

In the first embodiment, in the gaming machine 1, arcade server 2, and center server group 5, a processing is executed in the order shown in FIG. 17A, in relation to the above-described processing (character data loading (selection) process). FIG. 17A is a sequence chart showing a sequence of an operation carried out among the gaming machine 1, arcade server 2, and center server group 5.

In the gaming machine 1, in a step 100 a download request is transmitted to the arcade server 2 to download the application data, and thereafter the card information and the like is transmitted in the step 63 as described above. In the center server group 5 the processing proceeds to a step 301, in which the CPU 401 in the database server 103 uses the card information and password transmitted from the gaming machine 1 to perform an authentication process and determines whether or not the game player and figures are registered by, for example, referring to the figure management file 60. In the cases where registration is made, the processing proceeds to a step 302, as authenticated, to transmit a response signal indicating the authentication result to the gaming machine. In this case, in the database server 103, a similar authentication process is performed at the eight gaming machines 1 that are installed in each of the arcades A and B.

(Character Data Loading Process)

Further, in the first embodiment, in the gaming machine 1, transmission of character data loading instruction data, which is shown in the step 97A described above, is performed. In the center server group 5, the processing proceeds to a step 303A in which the processing following the flow chart shown in FIG. 18 is performed by the database server 103. FIG. 18 is a flow chart showing an operation procedure of the character data loading process. When this process is started the processing proceeds to a step 51 in which the figure management file 60 is searched, and the CPU 401 of the database server 103 determines whether or not there are stored in the figure management file 60 the records corresponding to all of the player ID and a plurality of figure IDs (main figure ID and partner figure ID) contained in the character data loading instruction data. If all the corresponding records are stored, the processing proceeds to a step 52, ad if there is no corresponding record, the character data loading process is ended.

In the step 52 the CPU 401 operates as the gaming object data extraction means, sets the player ID and figure ID (main figure ID and partner figure ID) to a retrieval key, and searches (extracts) the records corresponding to the retrieval key from the figure management file 60. In a subsequent step 54 the CPU 401 operates as loading and generating means, and the character data in each record searched in a step 53 is loaded, and a processing for updating the records corresponding to the player ID and main figure ID to other new records is performed. In the present embodiment, the character corresponding to the player ID and figure ID is the main character, and the character corresponding to the player ID and partner figure ID is other character which is of the partner. Updating the record in which is stored the character data of the main character to other record is the same as generating other gaming object data in the present invention. Hereinafter, update of the character data of the main character is described in detail.

FIG. 9A shows an example of the figure management file 60 after a character data update process of the main character is performed. FIG. 9A shows the case in which the play character with the player ID 60a, “0001” and the figure ID 60b, “1000” is selected as the main character, and the play character with the player ID 60a, “0001” and the figure IDs 60b, “1220” and “1350” is selected as the partner character. In this case the CPU 401 obtains the maximum value from the numerical value of each of the elements configuring the character data of the main and partner characters (each numerical value of the survival power 60d through the magical defensive power 60i), and performs an update processing for changing the numerical value of each element of the character data corresponding to the main character to the maximum value. Specifically speaking, for the survival power 60d, “300” as the numerical value of the character with the figure ID “1350” is the largest value (see FIG. 8A), the numerical value of the survival power 60d of the main character is changed from “100” to “300”, and the update process for performing the similar change is performed for other items. It should be noted in the present embodiment that the record corresponding to the character of the partner (shown as * in FIG. 9A) is deleted.

Further, FIG. 10A shows another example of the figure management file 60 after the update process of the character data of the main character. FIG. 10A shows the case in which the play character with the player ID 60a, “0001” and the figure ID 60b, “1000” is selected as the main character, and the arm character with the player ID 60a, “0001” and the figure IDs 60b, “2330”, “5000”, and “6012” is selected as the partner character. In this case the CPU 401 performs an update processing or adding the numerical value of each of the elements configuring the character data of the partner character (each numerical value of the survival power 60d through the magical defensive power 60i), to the numerical value of each element of the character data corresponding to main character. Specifically speaking, the numerical value of the attacking power of the main character before the update is “200”, and the numerical value of the attacking power of the arm character (item (weapon)) selected as the partner is “150”, but the attacking power of the main character after the update becomes “350” obtained by adding “150” to “200”.

It should be noted that the main character data update process is not limited to the cases described above, so, for example, the character data of the main character may be a mean value instead of the maximum value of the character data of the main and partner characters. Moreover, for the arm character, for example, an arm figure which is called “cursed sword” or the like may be prepared, and when this arm figure is selected as the partner character, a change may be performed such that the numerical value of the attacking power of the partner character (arm character) is deduced from the numerical value of the attacking power of the character data of the main character.

In this manner, when the database server 103 loads the character data of the partner character to the character data of the main character, of the plurality of character data items stored in the figure management file 60 so that other character data is generated, the ability of the partner character (may be one or more) can be reflected in the ability of the main character (based on the character data) to change (or improve) the ability of the main character. For this reason, the player does not get tired of the labyrinth battle game.

Moreover, in the present embodiment the character data corresponds to the figure ID (discrimination information) stored in the play figure 40 (object to be read), thus the ways to change the main character data are increased as the number or types of the play figures 40 held by the player increase, the interesting aspect of the labyrinth battle game played by the player is enhanced, and intentions of collecting the play figure 40 can be raised.

Furthermore, in the present embodiment the character data is managed in the figure management file 60 for each character corresponding to the figure ID and player ID, and even if the figure IDs are the same, and when the player IDs are different, they are stored and managed in the figure management file 60 as other character. Therefore, a plurality of players can use the same figure (the same figure ID) to enjoy the labyrinth battle game where other character is used. In addition, even if a certain player uses a figure to play a game, and updates the character data of a character that appears in the game, it does not influence the character data of a character which appears in the labyrinth battle game when other player uses the same figure to play the game. Therefore, the character data for each player can be protected, and an unnecessary conflict such as alteration of the data can be prevented.

Returning to FIG. 17A, the gaming machine 1 which executes transmission of the character data loading instruction data then performs transmission of entry data shown in the abovementioned step 71 (see FIG. 14A). Then, in the center server group 5 the processing proceeds to a step 304A, in which the game server 101 uses the entry data transmitted from each gaming machine 1, and performs player entry acceptance. Furthermore, in a subsequent step 305A, an update of participation information of the player, and the figure ID corresponding to the character generation instruction data (this figure ID has figure IDs of a newly registered figure which is not authenticated, and of a figure which is already authenticated but is authenticated again) are used to perform registration or update of the figure to the figure management file 60, and to generate or update the figure information. In a subsequent step 306A, players as opponents (four players in the present embodiment) are determined. It should be noted that the registration or update of the figure to the figure management file 60 is performed by adding the records which are related to the player ID and figure ID and stored in the figure management file 60, or by updating the records which involves change of the contents.

In a step 307A, the database server 103 extracts the game data of each player who is an opponent, and the processing proceeds to a step 308A, in which the extracted game data (character data of the main character, and the like) is transmitted to the arcade server 2. When the game data is received in the arcade server 2, the game data is transmitted to each gaming machine 1. It should be noted that if the character data of the partner character is loaded to the character data of the main character to generate other character data (updating of the records in the figure management file 60), a communication processing portion 404 and a communication control portion 405 of the database server 103 operate as the communication processing means of the present invention, and the game data having the above-described other character data in the main character is transmitted to the gaming machine 1 via the arcade server 2.

In the second embodiment, on the other hand, in the gaming machine 1, arcade server 2, and center server group 5, the processing is executed in the order shown in FIG. 17B in response to the above processing (character data exchange (selection) process). FIG. 17B is a sequence chart showing an operation sequence carried out among the gaming machine 1, arcade server 2, and center server group 5.

Moreover, in the second embodiment, in the gaming machine 1 transmission of the exchange-object identification data shown in the step 95B is performed. Then in the center server group 5, the processing proceeds to a step 303B in which the database server 103 performs an exchange character data transmission process. Here the CPU 401 of the database server 103 operates as the gaming object data extraction means, sets the two player IDs contained in the exchange-object identification data and the first and second figure IDs which are transmitted after associated with the player IDs to the retrieval keys, and searches (extracts) the records corresponding to the retrieval keys from the figure management file 60. The character data stored in the searched records are transmitted o the gaming machine 1 as the exchange character data.

The gaming machine 1 which receives the exchange character data allows the player to select the characteristic elements of the character data which are to be exchanged, and transmits the data related to the selected exchange characteristic elements to the center server group 5 as shown in a step 99B. The database server 103 of the center server group which receives the exchange characteristic elements proceeds to a step 304B, in which the CPU 401 operates as the data exchange means to perform the character data exchange process. The detail of the character data exchange process is described with reference to FIG. 9B and FIG. 10B.

FIG. 9B shows an example of the figure management file 60 after the character data exchange process is performed among the character data sharing the player ID. FIG. 9B shows the case in which the character with the player ID 60a, “0001” and the figure ID 60b, “1000” is selected as a character for exchange (referred to as “first character” hereinafter), and the character with the player ID 60a, “0001” and the figure ID 60b, “1220” is selected as the other character (referred to as “second character” hereinafter). In FIG. 9B, the magical power 60e and the magical attacking power 60h are selected as the characteristic elements for exchange, and the numerical values of the selected characteristic elements are exchanged. Specifically, the magical power and magical attacking power of the first character are “20” before exchange, and the magical power and magical attacking power of the second character are “200” before exchange (see FIG. 8B), but a processing for updating the former to “200” and the latter to “20” after exchange to obtain new records is performed. It should be noted that the parts indicating the exchanged numerical values are shown with a mark •.

In addition, FIG. 10B shows an example of the figure management file 60 after the character data exchange process is performed among the character data having different player IDs. In FIG. 10B, the character with the player ID 60a, “0001” and the figure ID, “1000” is selected as the first character, the character with the player ID 60a, “0012” and the figure ID “1101” is selected as the second character, and the characteristics elements of the character data selected to be exchanged are the survival power 60d, defensive power against a physical attack 60g, and item A 60j. in this case as well, the processing for updating to new records in which the exchange characteristic elements are exchanged is performed as with the case shown in FIG. 9B. It should be noted that the parts indicating the exchanged numerical values are shown with a mark • in FIG. 10B as well.

As above, when the database server 103 exchanges some or all of the characteristic elements configuring the character data in the two character data items of the character data (gaming object data) stored in the figure management file 60, the player can reflect the ability of one character (based on the character data) in the ability of another character to change (or improve, for example) the ability of the characters even if the player does not execute the labyrinth battle game (a game using an image). Therefore, the player does not get bored of the labyrinth battle game.

Moreover, in the present embodiment the character data is related to the figure ID (discrimination information) stored in the play figure 40 (object to be read), thus the ways to change the character data are increased as the number of the types of play figures 40 held by the player increase, the interesting aspect of the labyrinth battle game played by the player is enhanced, and intentions of collecting the play figure 40 can be raised.

As in the present embodiment, if the characteristic elements of the character data corresponding to the figures held by different players can be exchanged between the players, the data related to the characteristic elements of the character data can be made as the objects for trade.

Furthermore, in the present embodiment as well, the character data is managed in the figure management file 60 for each character corresponding to the figure ID and player ID, and even if the figure IDs are the same, and when the player IDs are different, they are stored and managed in the figure management file 60 as other character. Therefore, a plurality of players can use the same figure (the same figure ID) to enjoy the labyrinth battle game where other characters are used. In addition, even if a certain player uses a figure to play a game, and updates the character data of a character that appears in the game, it does not influence the character data of a character which appears in the labyrinth battle game when other player uses the same figure to play the game. Therefore, the character data for each player can be protected, and an unnecessary conflict such as alteration of the data can be prevented.

Returning to FIG. 17B, the gaming machine 1 which executes the transmission of the characteristic elements for exchange then performs transmissions of the entry data shown in the above-described step 71 (see FIG. 14B) is transmitted. Then, in the center server group 5 the processing proceeds to a step 305B, in which the game server 101 uses the entry data transmitted from each gaming machine 1, and performs player entry acceptance. Furthermore, in a subsequent step 306B, an update of participation information of the player, and the figure ID corresponding to the character generation instruction data (this figure ID has figure IDs of a newly registered figure which is not authenticated, and of a figure which is already authenticated but is authenticated again) are used to perform registration or update of the figure to the figure management file 60, and to generate or update the figure information. In a subsequent step 307B, players as opponents (four players in the present embodiment) are determined. It should be noted that the registration or update of the figure to the figure management file 60 is performed by adding the records which are related to the player ID and figure ID and stored in the figure management file 60, or by updating the records which involves change of the contents.

In a step 308B, the database server 103 extracts the game data of each player who is an opponent, and the processing proceeds to a step 309B, in which the extracted game data is transmitted to the arcade server 2. When the game data is received in the arcade server 2, the game data is transmitted to each gaming machine 1. It should be noted that if the character data exchange process is performed (updating of the records in the figure management file 60), a communication processing portion 404 and a communication control portion 405 of the database server 103 operate as the communication processing means of the present invention, and the game data having one character data which is the object of the exchange processing is transmitted to the gaming machine 1 via the arcade server 2.

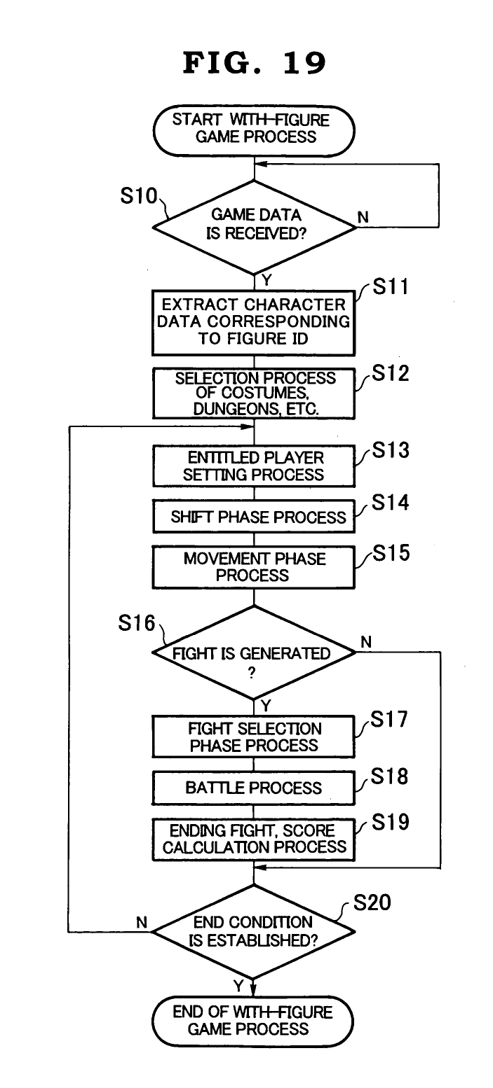

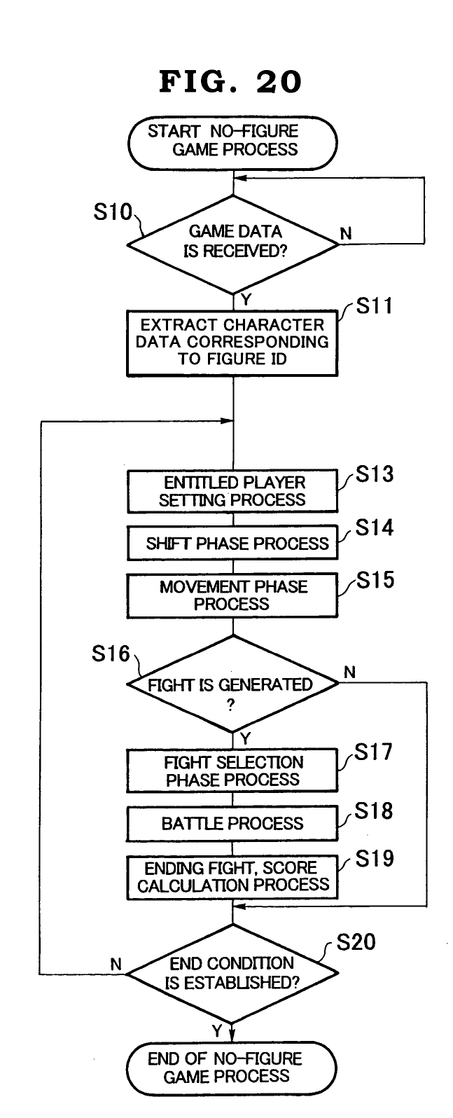

The gaming machine 1 performs a with-play figure game process and a no-play figure game process according to the flow charts shown in FIG. 19 and FIG. 20. It should be noted that in the following explanation, FIG. 19, and FIG. 20, the play figures are explained merely as figure. FIG. 19 and FIG. 20 are flow charts respectively showing operation procedures of a game process in the with-figure mode (with-figure game process) and a game process in the no-figure mode (no-figure game process).

(With-Figure Game Process)

When the with-figure game process is started, the gaming machine 1 proceeds to a step 10 shown in FIG. 19 in which the gaming machine 1 waits until receiving the game data from the arcade server 2. After receiving the game data, the gaming machine 1 causes the RAM 33 to store it once, and the processing proceeds to a step 11, in which the main CPU 32 extracts the character data corresponding to the figure ID of the figure 40 (main figure ID) used by the player. In this manner, the extracted character data is used to perform the game process in the with-figure mode. Next, the processing proceeds to a step 12, in which a processing of selecting costumes, dungeons and the like is performed.

Here, the main CPU 32 sets selections for the following items in the main display 11 more widely than those for the no-figure game process. In this case, a selection screen which is not shown is displayed in the main display 11 so that the player can select the following items. Specifically, an attribute of the character (in the present embodiment, a costume that the character wears) corresponding to the figure 40 which is subjected to new settings and authenticated (or which is already authenticated), and a dungeon used in the labyrinth battle game can be selected by the player.

When the player selects a desired costume and dungeon by touching the main display 11 with a finger, information indicating the selection is inputted from the touch panel 11a to the main CPU 32. The step 12 is a processing for the with-figure mode, thus a plurality of types of costumes (three types, for example) can be selected, and two types of dungeons, i.e. a regular form or a special form, can be selected. On the other hand, there is no processing in the no-figure game process that is the same as the processing of the step 12, thus only a default costume which is defined for each character is set, and a regular form of dungeon is set.

The processing then proceeds to a step 13, in which an entitled-player setting process is performed. In this step any of the players (four players in the present embodiment) who participate in the labyrinth battle game is set as a player who can shift the labyrinth (an entitled player for the shifting), which is described hereinafter. Each of the players is set as an entitled player for the shifting.

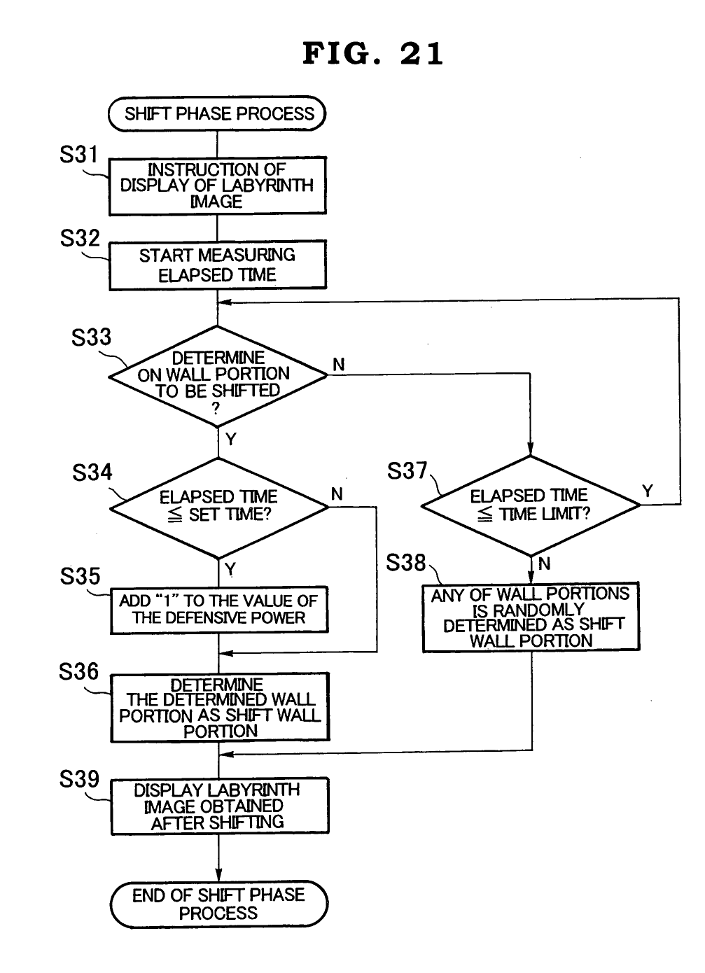

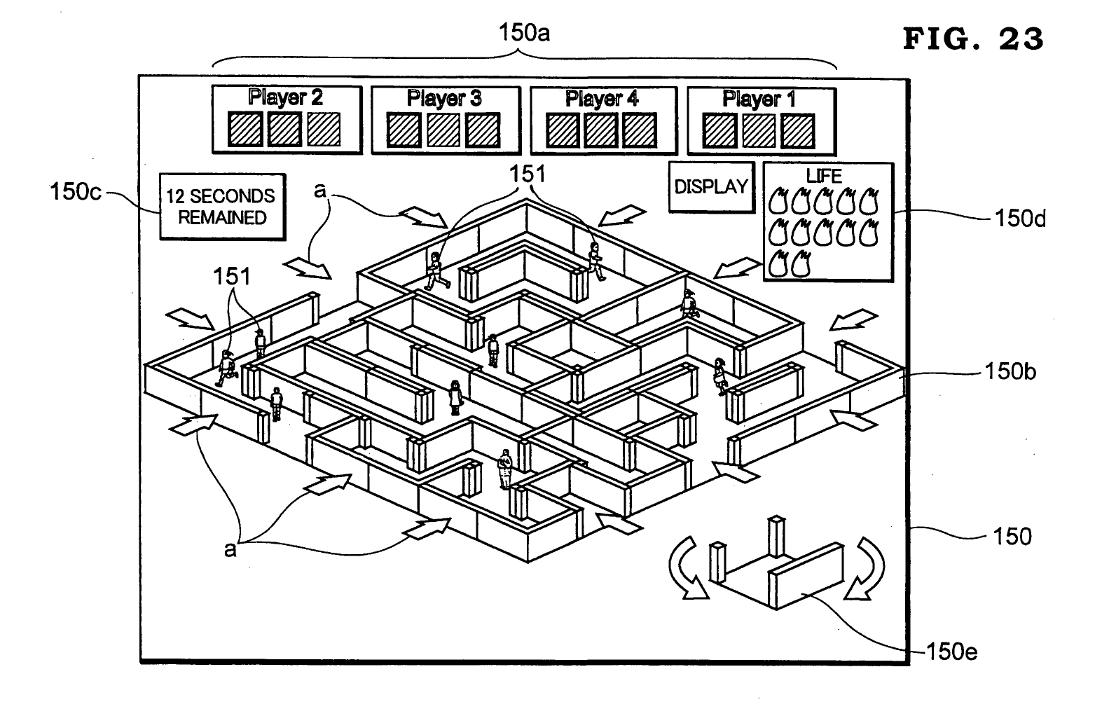

In a subsequent step 14, a shift phase process is performed. The shift phase process is performed according to the flow chart shown in FIG. 21. When the shift phase process is started, the main CPU 32 proceeds to a step 31, in which an instruction is given to the image control circuit 71 to cause the main display 11 to display a labyrinth image 150 as the one shown in FIG. 23. The labyrinth image 150 has an entitlement table display portion 150a (players 1, 2, 3 and 4) which displays the presence or absence of the shift entitlement of the four players, or the attack priority, and a labyrinth display portion 150b which displays an image of the labyrinth configured with a plurality of wall portions, wherein an image of a plurality of characters 151 (an image of gaming objects of the present embodiment) is displayed in the labyrinth. Moreover, as the input prompting image of the present invention, the labyrinth image 150 has a timer display portion 150c which displays the remaining time in which are used the set time or an after-mentioned first elapsed time of the present invention, and encourages the players to perform an operation input, a life display portion 150d, and an explanation display portion 150e for showing an explanation on how to shift the wall portions. In the timer display portion 150c, the main CPU 32 operates as the display control means, and causes the main display 11 to display, and the numeric values displayed are decreased as the first elapsed time increases.

Next, the processing proceeds to a step 32, in which the main CPU 32 operates as the time measuring means to start measuring the first elapsed time. The first elapsed time indicates the time period elapsed from when the player can perform an operation input (the progress operation input or determination operation input) indicating that a wall portion to be shifted (shift wall portion) is determined on the screen (input start time), to when the player actually touches a desired arrow a to perform the progress operation input or determination operation input. In a subsequent step 33 the main CPU 32 determines whether or not a shift wall portion is determined. If the shift wall portion is determined, the processing proceeds to a step 34, if not, the processing proceeds to a step 37. In the step 34 the main CPU 32 operates as the determination means to determine whether or not the first elapsed time is equal to or less than a first set time (10 seconds in the present embodiment). If the first elapsed time is within the first set time, the processing proceeds to a step 35, and if not, the processing proceeds to a step 36 without executing the step 35. In the step 35, the main CPU 32 operates as the bonus granting means, and add “1” to the value of the defensive power. The larger the numeric value of the defensive power becomes, the more the defensive power against attacks from other characters is enhanced, thus a beneficial bonus is obtained when the players proceed with the labyrinth battle game. In the following step 36 the main CPU 32 operates as the performance determination means to set a determined wall portion as the shift wall portion and determine an action (shifting the wall) of the character.

On the other hand, if the processing proceeds from the step 33 to the step 37, it is determined whether or not the first elapsed time is within a time limit (15 seconds in the present embodiment) for determining to shift a wall portion. If the first elapsed time is within the time limit for the shift determination, the processing returns to the step 33, and if not, the processing proceeds to a step 38, in which a random number extracted from the sampling circuit 36 may be used to randomly set any of the wall portions to the shift wall portion. Then, the processing proceeds to a step 39, in which a labyrinth image which is obtained after shifting the wall portion is displayed, and thereafter the shift phase process is ended. In this manner, determination on the shift wall portion can be performed within the time limit (15 seconds) for determining to shift a wall portion, but if it is performed earlier than the time limit (within 10 seconds), “1” is added to the value of the defensive power, thereby providing the player with a bonus.

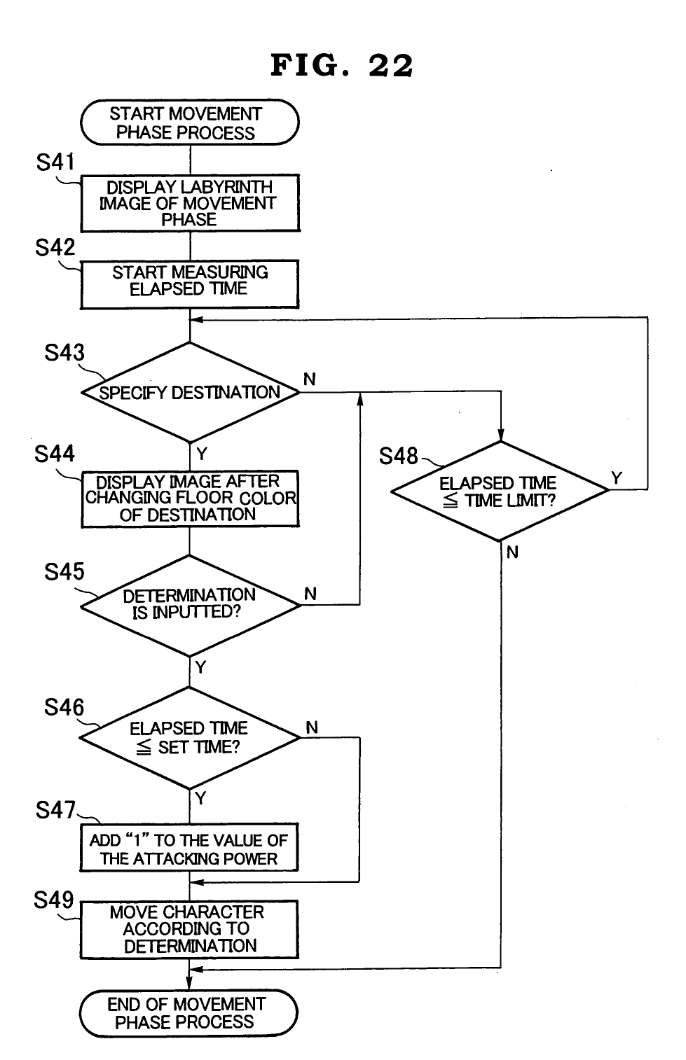

Next, the processing proceeds to a step 15, in which a movement phase process is performed. The movement phase process is performed according to the flow chart shown in FIG. 22.

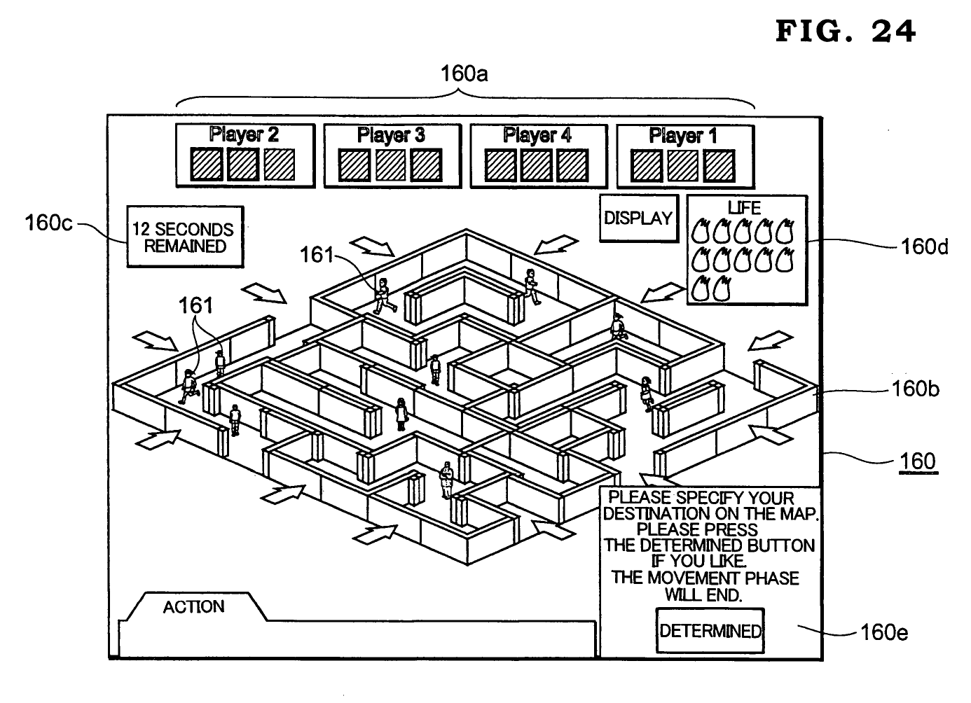

When starting the movement phase process, the main CPU 32 proceeds to a step 41 to instruct the image control circuit 71 and cause the main display 11 to display the labyrinth image 160 of a movement phase shown in FIG. 24. The labyrinth image 160 also has various display portions as with the labyrinth image 150 (an entitlement table display portion 160a, labyrinth display portion 160b, timer display portion 160c, and life display portion 160d), wherein a character 161 is disposed inside the labyrinth, and the labyrinth image has a destination specification display portion 160e having a display of a specification request message for a destination and a determination button for a destination.

Next, the processing proceeds to a step 42, in which the main CPU 32 operates as the time measuring means to start measuring a second elapsed time. The second elapsed time indicates the time period elapsed from when the player can perform an operation input (specification of a destination) for specifying a destination of his character (input start time), to when the player performs an operation input (progress operation input or determination operation input) for proceeding with the game by touching the destination specification display portion 160e. In a subsequent step 43, the main CPU 32 determines whether or not a destination is specified, and if a destination is specified the processing proceeds to a step 44, and if not the processing proceeds to a step 48. In the step 44, an image with a changed display color of the floor on which the character moves from its original position to a destination is displayed (not shown in the figures) to highlight the destination, and the processing proceeds to a step 45. Then, it is determined whether or not the player touches the determination button of the destination specification display portion 160e (to determine a destination). If the button is touched the processing proceeds to a step 46, and if not the processing proceeds to the step 48. In the step 46, the main CPU 32 operates as the determination means to determine whether or not the second elapsed time is equal to or less than a second set time (15 seconds in the present embodiment). In this step, if the second elapsed time is within the second set time, the processing proceeds to a step 47, and if not the processing proceeds to a step 49 without executing the step 47. In the step 47, the main CPU 32 operates as the bonus granting means to add “1” to the value of the attacking power. The larger the numeric value of the attacking power becomes, the more the attacking power is enhanced, thus a beneficial bonus is obtained when the players proceed with the labyrinth battle game.

On the other hand, when the processing proceeds to the step 48, it is determined whether or not the second elapsed time is within the time limit for destination determination (30 seconds in the present embodiment). If the second elapsed time is within the time limit for destination determination, the processing returns to the step 43, and if not, the movement phase process is ended (in this case, the character does not move and waits at its original place). Further, in the step 49 the main CPU 32 operates as the performance determination means to determine an action of the character (movement inside the labyrinth) according to the determination made in the previous steps, and displays an image obtained after the character is moved. Then, the movement phase process is ended. In this manner, determination of a destination can be performed within the time limit for destination determination (30 seconds), but if it is performed earlier than the time limit (within 15 seconds), “1” is added to the value of the attacking power so the player can be provided with a bonus. It should be noted that in the movement phase process in the with-figure mode, a special card (a teleport card with which random movement can be performed, a through-wall card with which the character can pass through a wall, or the like) can be used as a reward which cannot be obtained in the no-figure mode.

Returning to FIG. 19, the processing proceeds to a step 16 following the movement phase process, in which the main CPU 32 determines whether or not a fight is generated. Here, if a fight is generated (in the case where a plurality of characters are present in a range in the labyrinth where an attack can be begun), the processing proceeds to a step 17, but if no fight is generated, the processing proceeds to a step 20.

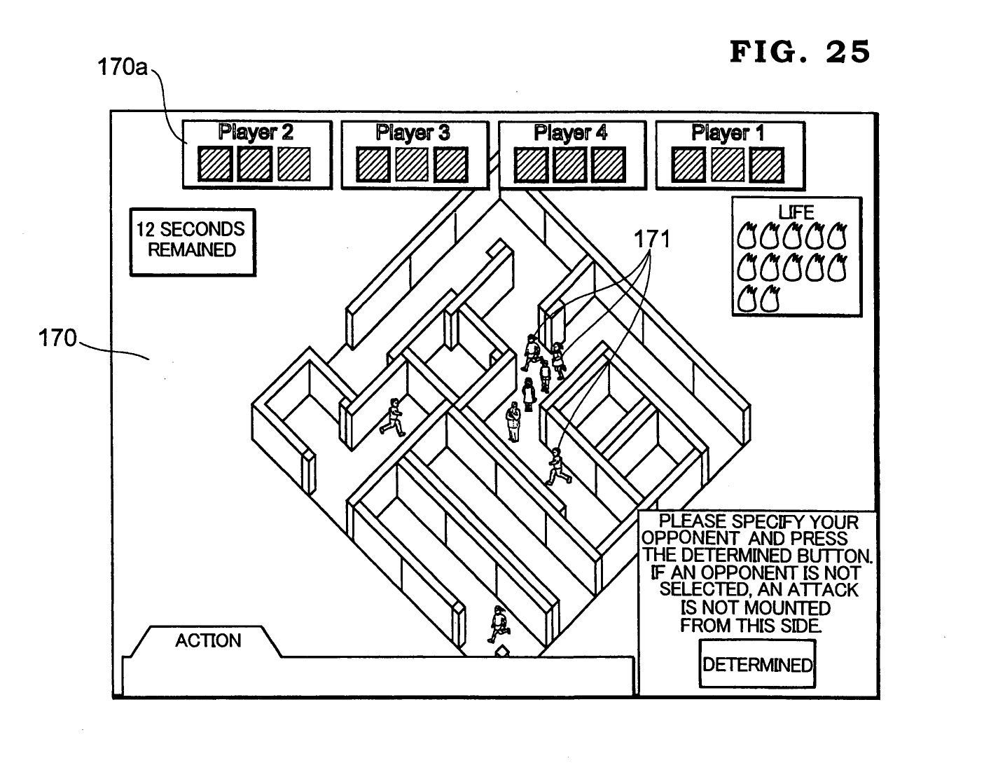

In the step 17 a fight selection phase process is performed. Here, the main CPU 32 instructs the image control circuit 71 and causes the main display 11 to display a fight selection image 170 (having an entitlement table display portion 170a, and characters are disposed in the labyrinth) such as the one shown in FIG. 25. With reference to this fight selection image 170, each player (four players in the present embodiment) selects an opponent for an attack, and selects to use a technique card or not, the technique card showing techniques of each character, and also selects which technique card to use. It should be noted that the order of attacks mounted by each character is based on a shift-entitled player.

In the fight selection phase process, the technique card can be selected (the technique card is provided to the characters at the end of the game as a reward in accordance with a record of a battle). In the case of the with-figure mode, there are more types of technique cards to be provided and more selections of the technique cards than in the case of the no-figure mode. Further, in the with-figure mode, probability of being provided with a rare card, which generates beneficial bonus information (for example, a special technique is generated), is set higher than the no-figure mode. Specifically, if the player plays a game in the with-figure mode by using the figure 40, multiple technique cards including the rare card are provided, whereby the probability of being able to use them is increased.

In this case, the main CPU 32 searches a technique selection table for a first mode (for example, table in which a random number is associated with a technique card to be selected). When comparing the technique selection table for a first mode with a technique selection table for a second mode, the range of random numbers in relation to the rare card is set more widely in the former technique selection table than the latter technique selection table.

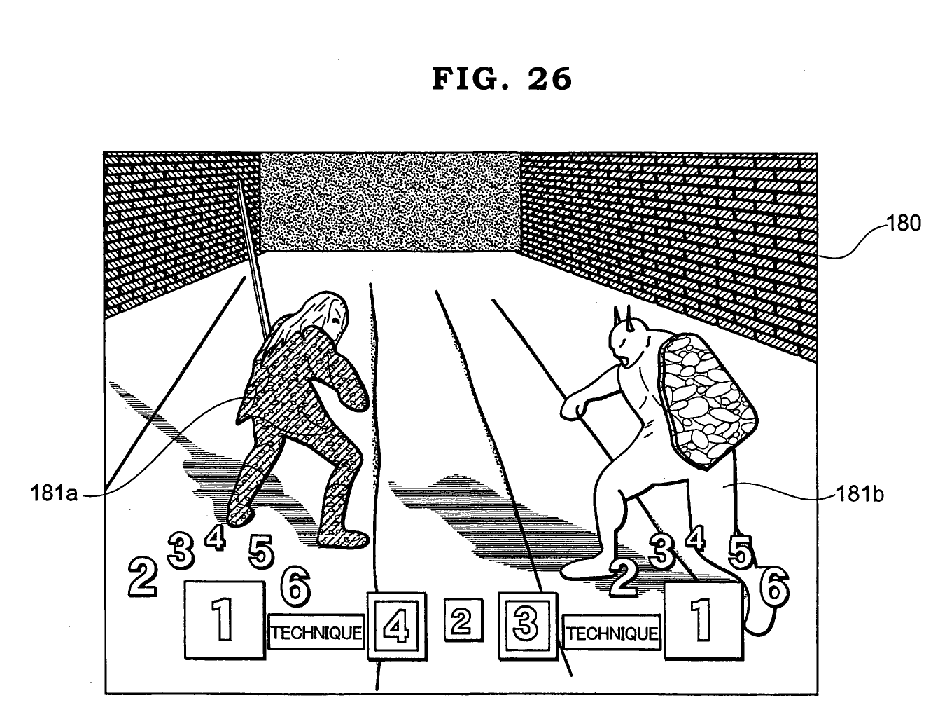

In a subsequent step 18 a battle process is performed. Specifically, attacking power and defensive power are specified and a range of attack is set for each character according to the character data thereof, whereby the outcome of the game is determined by comparing the value of the attacking power and the value of the defensive power in battling characters, upon consideration of whether using the technique card or not. In this case, the sub display 12 displays the battle image 180 showing a scene where a characters 181a and 181b battle, as shown in FIG. 26. It should be noted that when the main character (play character) operated by the player loads the character data of an arm character, an image may be displayed such that the play character is caused to have an image (gaming object image) of an arm character corresponding to the arm character in the battle image 180.

It should be noted that he battle process is performed in the step 18 in the second embodiment as well. Specifically, attacking power and defensive power are specified and a range of attack is set for each character according to the character data thereof, whereby the outcome of the game is determined by comparing the value of the attacking power and the value of the defensive power in battling characters, upon consideration of whether using the technique card or not. In this case, the sub display 12 displays the battle image 180 showing a scene where a characters 181a and 181b battle, as shown in FIG. 26.

Next, in a step 19 the fight is ended and a score calculation process is performed. In this step lives are added or deducted according to a result of the battle process of the step 18 (the type of the character which becomes the opponent, and victory or defeat), and a title or a sacred gem is provided to the character or deprived from the character (in the with-figure mode, various titles such as “champion”, “master” or “professional” are provided in accordance with the performance of the character). In the subsequent step 20 it is determined whether an end condition is established or not. If the end condition is established (score is not more than 0), the with-figure game process is ended. If it is not established (score>0), the processing returns to the step 13, and the above processing is repeated. For the player with a score of 0 or less, the labyrinth battle game is ended, and, in place of this player, the main CPU 32 participates in the battle as another character. It should be noted that, although not shown, if a player with no life uses a recovery card or inserts a coin, a certain amount of life is recovered.

As described above, upon determination of a shift wall portion or a destination within the set time for each process of the shift phase process and the movement phase process in the gaming machine 1, the values of the defensive power and the attacking power are added, and the defensive power and attacking power are enhanced. Moreover, when the characters battle, these values are used to determine which character wins or loses, and the progress of the labyrinth battle game is controlled. For this reason, the addition process to the values of the defensive power and the attacking power is the incentive for promptly allowing each player to determine on a shift wall portion and a destination. Accordingly, the player does not have to prolong operation input needlessly, and early operation input can be prompted and the progress of the entire game can be hastened.

Moreover, the timer display portions 150c and 160c are displayed respectively in the shift phase process and the movement phase process, and they display numbers that gradually decrease along a time elapsing from the start of measurement of an elapsed time, thus it is possible to encourage the players to perform an input operation as soon as possible.

Particularly, as in the gaming machine 1, when playing a type of a game in which a plurality of players participate, if one player prolongs an operation other players have to wait, thereby causing stress or frustration. However, this does not happen in the gaming machine 1, and each of the players can have the true fascinating aspect of the game, which is supposed to be obtained through the labyrinth battle game.

(No-Figure Game Process)

The no-figure game process is performed, as shown in FIG. 20, by following a flow chart which is substantially the same as the with-figure game process explained previously using FIG. 19. When comparing the no-figure game process with the with-figure process, the difference is that the no-figure game process is not provided with the step 12.

In the no-figure mode, a game is proceeded without using a figure, when the game data is received and stored in the RAM 33, if the response signal contains a figure ID (if there is an authenticated figure), the character data corresponding to the figure ID is extracted.

Moreover, since the step 12 is not executed, unlike the with-figure mode described, above, the players have no choice in the costumes and dungeons, thus the content of a game is limited in comparison with the labyrinth battle game in the with-figure mode. Furthermore, the selections in the various cards that can be selected in the step 15 and the technique cards that can be selected in the step 17 are limited.

In addition, a title corresponding to a battle result is provided to a character in the step 19, but in the no-figure mode a title, “ronin”, is given even if a good battle result is obtained.

In this manner, in the gaming machine 1 a game can be proceeded not only when the figure 40 is used but also when the figure 40 is not used. Also, when the figure 40 is used, a benefit that cannot be obtained when the figure 40 is not used is obtained, so the players can have the intentions of collecting the figure, and the fascinating aspect of the game which is obtained by making full use of the characteristics of the labyrinth battle game can be provided. Especially when playing the labyrinth battle game using the figure 40, there are advantages depending on the progress status of the game, such that scores of the character matching the figure are increased, the defensive power or attacking power is enhanced, and a title is provided, thus it is possible to encourage the players to repeatedly use the figure, and satisfy the players.

The gaming server and gaming system of the present invention are described based on the above-described embodiments. However, the present invention is not limited to the above embodiments. For example, in the above first embodiment, the CPU 401 of the database server 103 which is the same as the gaming server is operated as the loading and generating means, but the main CPU 32 of the gaming machine 1 may be operated as the loading and generating means. Specifically, each character data item related to the figure which is set to the authentication unit 15 by the player or the figure for loading may be transmitted to the gaming machine 1 by the database server 103, and the main CPU 32 of the gaming machine 1 may load the character data of the partner character onto the character data of the main character to generate other character data.

Further, for example, in the second embodiment the CPU 401 of the database server 103 which is the same as the gaming server is operated as the data exchange means, but the main CPU 32 of the gaming machine 1 may be operated as the data exchange means. Specifically, two character data items related to the figure which is set to the authentication unit 15 by the player may be transmitted to the gaming machine 1 by the database server 103, and the main CPU 32 of the gaming machine 1 may exchange some or all of the characteristic elements between the two character data items.

Moreover, in the present embodiment the character data (gaming object data) items are related to the player ID (player information) and figure ID (discrimination information) and stored in the data storage portion 406 (gaming object data storage means) for each character (gaming object). However, the character data (gaming object data) may be related only to the figure ID (discrimination information) and stored in the data storage portion 406 (gaming object storage means) for each character (gaming object). In this case, the CPU 401 of the database server 103 operates as the gaming object data extraction means to extract the character data (gaming object data) corresponding to the figure ID from the data storage portion 406 (gaming object data storage means).

In the present embodiments, explanations are provided by taking the figure as an example of an object to be read. The present invention, however, can applied to a case in which an object to be read which is different from the figure is used. For example, a game card or cassette in the form of a card, in which a picture or figure of a character is drawn and ID information and the like are stored, or cassette may be used. Also, the present invention provides explanations by taking the gaming machine 1 where the labyrinth battle game can be played, as an example, but the present invention can be applied to a gaming machine in which other game can be played. Examples of such gaming machine include a gaming machine on which can be played a game where a plurality of players can appear, such as baseball, soccer or the like, and in which the game can be played by doing a simulation on team play by using a figure or cassette corresponding to each of the players.

Moreover, the gaming machine 1 is equipped with the main display 11 and sub display 12 for displaying game images, but the main display 11 and the sub display 12 may be provided separately.

In the above embodiments, explanations are provided by taking an example of a case where the gaming machine 1 has reading means, and player information reading means. However, the gaming system (the gaming system of the present invention) may be configured such that each of the above means is provided to either the gaming machine 1 or the arcade server 2. Furthermore, the gaming system may be configured by providing a device having the same function as each of the above means separately from the gaming machine 1 and arcade server 2.

What is claimed is:

1. A gaming server which is connected to a gaming machine on which a game is played which utilizes an image of a gaming object which shows a figure or other object appearing in the game, wherein the gaming server comprises:
a loading and generating unit which loads, out of the gaming object data items indicating the characteristics of the gaming object, the gaming object data of another gaming object onto the gaming object data of the main gaming object to generate other gaming object data; and
a communication processing unit which transmits the gaming object data generated by the loading and generating unit to the gaming machine.

2. The gaming server according to claim 1, further comprising a gaming object data storage unit which relates the gaming object data indicating the characteristics of a gaming object to the gaming object and stores thus obtained gaming object data for each gaming object,
wherein the loading and generating unit loads the gaming object data of another gaming object stored in the gaming object data storage unit onto the gaming object data of the main gaming object, which is stored in the gaming object data storage unit, and generates other gaming object data corresponding to the main gaming object.

3. A gaming system on which a game is played which utilizes an image of a gaming object which shows a figure or other object appearing in a game, the gaming system comprising:
a reading unit which reads discrimination information from an object to be read which stores discrimination information corresponding to the gaming object;
a gaming object data storage unit which relates gaming object data indicating the characteristics of the gaming object to the discrimination information and stores thus obtained gaming object data for each gaming object;
a gaming object data extraction unit which extracts, from the gaming object data storage unit, the gaming object data corresponding to the discrimination information read from the object to be read by the reading unit; and
a loading and generating unit which loads gaming object data of another gaming object onto the gaming object data of the main gaming object out of the gaming object data items extracted by the gaming object data extraction unit, and generates other gaming object data.

4. The gaming system according to claim 3, further comprising a player information reading unit which reads player information which identifies a player who plays the game,
wherein the gaming object data storage unit relates the gaming object data to the player information and discrimination information to store the gaming object data for each gaming object, and
wherein the gaming object data extraction unit extracts the gaming object data corresponding to the player information and the discrimination information which are read by the player information reading unit and the reading unit, from the gaming object data storage unit.

5. The gaming system according to claim 3, comprising an arcade server installed in a game arcade, a plurality of gaming machines connected communicably to the arcade server via dedicated lines, and an in-arcade router installed in the game arcade, wherein the arcade server is connected to a gaming server via the in-arcade router, communication lines and the Internet.

6. The gaming system according to claim 3, wherein the gaming machine comprises another gaming object data loading instruction information input portion in which a player inputs instruction for loading the gaming object data of another gaming object, and wherein another gaming object data loading instruction information which is input from the another gaming object data loading instruction information input portion is transmitted to a gaming server.

7. The gaming system according to claim 6, wherein, when the gaming server receives the another gaming object data loading instruction information, the loading and generating unit loads the gaming object data of another gaming object, which is stored in the gaming object data storage unit, onto the gaming object data of the main gaming object, which is stored in the gaming object data storage unit, on the basis of the another gaming object data loading instruction information, and generates other gaming object data.

8. The gaming system according to claim 4, wherein the player information is stored in an ID card.

9. A gaming server which is connected to a gaming machine on which a game is played which utilizes an image of a gaming object which shows a figure or other object appearing in a game, gaming server comprising:
a data exchange unit which exchanges, for two different gaming object data items of the gaming object data items configured by the plurality of characteristic elements which indicate the characteristics of the gaming object, some or all of the characteristic elements; and
a communication processing unit which transmits at least one of the gaming object data items with the characteristic elements exchanged by the data exchange unit, to the gaming machine.

10. The gaming server according to claim 9, further comprising a gaming object data storage unit which relates gaming object data configured with the plurality of characteristic elements indicating the characteristics of the gaming object to the gaming object and stores thus obtained gaming object data for each gaming object,
wherein the data exchange unit exchanges some or all of the characteristic elements for two different gaming object data items stored in the gaming object data storage unit.

11. A gaming system on which a game is played which utilizes an image of a gaming object which shows a figure or other object appearing in a game, the gaming system comprising:
a reading unit which reads discrimination information from an object to be read in which is stored discrimination information corresponding to the gaming object;
a gaming object data storage unit which relates gaming object data configured with a plurality of characteristic elements indicating the characteristics of the gaming object to the discrimination information and stores thus obtained gaming object data for each gaming object;
a gaming object data extraction unit which extracts, from the gaming object data storage unit, the gaming object data based on the discrimination information read from the object to be read by the reading unit; and
a data exchange unit which exchanges some or all of the characteristic elements configuring two different gaming object data items extracted by the gaming object data extraction unit.

12. The gaming system according to claim 11, further comprising a player information reading unit which reads player information for identifying the player,
wherein, the gaming object data storage unit relates the gaming object data to the player information and the discrimination information and stores the gaming object data for each gaming object; and
the gaming object data extraction unit extracts, from the gaming object data storage unit, gaming object data based on the player information and discrimination information which are read by the player information reading unit and the reading unit.

13. The gaming system according to claim 11, further comprising an arcade server installed in a game arcade, a plurality of gaming machines connected communicably to the arcade server via dedicated lines, and an in-arcade router installed in the game arcade, wherein the arcade server is connected to the gaming server via the in-arcade router, communication lines and the Internet.

14. The gaming system according to claim 11, wherein the gaming machine comprises an exchange element identification information input portion in which a player inputs instruction for exchanging some or all of the characteristic elements configuring the two different gaming object data items as the exchange elements, wherein exchange element identification information which is input from the exchange element identification information input portion is transmitted to the gaming server.

15. The gaming system according to claim 14, wherein, when the gaming server receives the exchange element identification information, the data exchange unit exchanges some or all of the characteristic elements configuring the two different gaming object data items stored in the gamine object data storage unit, based on the exchange element identification information.

16. The gaming system according to claim 12, wherein player information for identifying the player is stored in an ID card.
